(19) United States
(12) Patent Application Publication
(10) Pub. No.: US 2008/0139771 A1
(43) Pub. Date: Jun. 12, 2008

(54) Thio(Meth)Acrylates, Mixtures For Producing Transparent Plastics, Transparent Plastics And Method For Their Production And Use

(75) Inventors: Bardo Schmitt, Mainz (DE); Joachim Knebel, Alsbach-Hahnlein (DE); Patrik Hartmann, Buttelborn (DE)

Correspondence Address: OBLON, SPIVAK, MCCLELLAND MAIER & NEUSTADT, P.C., 1940 DUKE STREET, ALEXANDRIA, VA, 22314, US

(73) Assignee: Roehm GmbH, Darmstadt (DE)

(21) Appl. No.: 11/813,216

(22) PCT Filed: Dec. 3, 2005
(86) PCT No.: PCT/EP05/12963

§ 371 Date: Jul. 2, 2007

(30) Foreign Application Priority Data
Jan. 24, 2005 (DE) 10 2005 003 303.2

(51) Int. Cl. C08F 28/04

(52) U.S. Cl. 526/289

(57) ABSTRACT

The present invention relates to thio(meth)acrylates, obtainable via reaction of compounds of the formula (I) and (II)

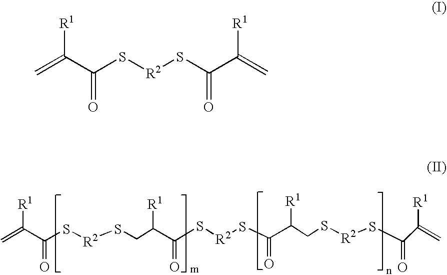

where each R¹, independently of the others, is hydrogen or a methyl radical,
each R², independently of the others is a linear or branched, aliphatic or cycloaliphatic radical, or a substituted or unsubstituted aromatic or heteroaromatic radical, and each of m and n, independently of the others, is whole number greater than or equal to 0, where m+n>0,
with thiol compounds which encompass at least two thiol groups.

The present invention relates to thio(meth)acrylates and mixtures for preparing transparent plastics which comprise these thio(meth)acrylates. The present invention further relates to transparent plastics which can be prepared from the mixtures, and to a process for their preparation. The present invention also relates to the use of transparent plastics for producing optical, especially ophthalmic, lenses.

Spectacles have become an essential component of everyday life. Among these, spectacles with plastics lenses have in particular gained importance recently, because they weigh less and are less breakable than spectacle lenses composed of inorganic materials, and can be coloured by means of suitable dyes. The production of plastics spectacle lenses generally uses high-transparency plastics obtainable, by way of example, from diethylene glycol bis(allyl carbonate) (DAC), thiourethane compounds having α,ω-terminated multiple bonds or sulphur-containing (meth)acrylates.

DAC plastic has very good impact strength and transparency, and good processability. However, a disadvantage is that the relatively low refractive index n_{D} of about 1.50 requires that both the centre and the edges of these plastics lenses be reinforced, the spectacle lenses being correspondingly thick and heavy. This markedly reduces the wearer comfort of spectacles with DAC plastics lenses.

The specification DE 434251 discloses sulphur-containing polymethacrylates which are obtained via free-radical copolymerization of a monomer mixture composed of compounds of the formula (1) and (2).

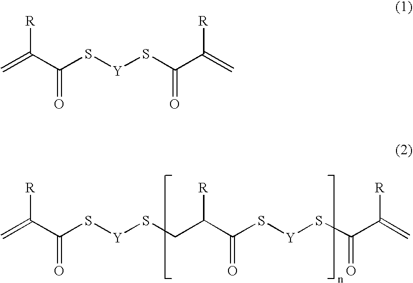

Here, Y is an unbranched or branched, acyclic or cyclic alkyl radical having from 2 to 12 carbon atoms, or an aryl radical having from 6 to 14 carbon atoms, or an alkaryl radical having from 7 to 20 carbon atoms, and the carbon chains here may have interruption by one or more ether or thioether groups. R is hydrogen or methyl and n is a whole number in the range from 1 to 6.

According to DE 4234251, the monomers of the formula (1) and (2) generally have a molar ratio of from 1:0.5 to 0.5:1. The monomer mixture is prepared via reaction of at least two moles of (meth)acryloyl chloride or (meth)acrylic anhydride with one mole of a dithiol, by reacting the (meth)acryloyl chloride or (meth)acrylic anhydride in an inert organic solvent and the dithiol in aqueous alkaline solution. Suitable solvents mentioned are methyl tert-butyl ether, toluene and xylene, the dielectric constant of these at 20° C. being 2.6, 2.4 and, respectively, from 2.3 to 2.6.

The plastics described in DE 4234251 are colourless, rigid and slightly brittle and have a high refractive index n_{D} in the range from 1.602 to 1.608. The Abbe number is from 35 to 38. These plastics too, therefore, have only limited suitability for spectacle lenses Again, this specification gives no information concerning the glass transition temperature of the plastics.

The specification WO 03/011925 describes the polymerization of thiomethacrylates with polyethylene glycol derivatives. The resultant plastics may be used, inter alia, for producing optical lenses. A disadvantage of these lenses is their mechanical properties. In particular, for example impact strength is insufficient for many requirements.

In the light of the prior art, it was then an object of the present invention to provide compounds which are suitable as a constituent of mixtures for producing optical lenses, where the plastics have ideal mechanical properties in particular high impact strength, together with a high refractive index preferably greater than 1.59, and a maximum Abbe number, preferably greater than 36. In particular, it should be possible to produce plastics spectacle lenses which have a low level of dispersion and no colouring at the edges.

Good handling of the compound should moreover be possible. In particular, therefore, the compound should have low viscosity together with very low volatility. Furthermore, it should be possible to add a large amount of the compound to the mixture for preparing the plastic.

Another object on which the present invention was based was to provide access to a compound for producing a high-transparency plastic with improved mechanical properties even at temperatures above room temperature. In particular, the plastic obtainable using the compounds a should have maximum glass transition temperature, preferably greater than 80° C.

It was therefore an object of the present invention to provide a high-transparency plastic which can be prepared from the starting material composition in a simple manner, on an industrial scale and at low cost. In particular, it should be obtainable via free-radical polymerization from a mixture which at atmospheric pressure and at temperatures in the range from 20° C. to 80.0° C., is flowable.

Another object on which the present invention was based was to provide application sectors and possible uses for the new compounds.

Another object of the invention was to provide coating materials for synthetic fibres which have a high refractive index. These coating materials should have maximum adhesion and good processability.

Thio(meth)acrylates with all of the features of Patent Claim 1 achieve these objects, and also achieve other objects which although not explicitly mentioned are readily derivable or deducible from the circumstances discussed in the introduction above. Advantageous modifications of the inventive thio(meth)acrylates are protected in the subclaims dependent on claim 1. The mixtures and transparent plastics obtainable from the inventive thio(meth)acrylates are claimed, as also is a process for preparation of transparent plastics. The use claim protects a preferred use of the inventive high-transparency plastic. Another product claim describes an optical preferably ophthalmic lens which comprises the inventive high-transparency plastic.

The present invention therefore provides thio(meth)acrylates obtainable via reaction of compounds of the formula (I) and/or (II)

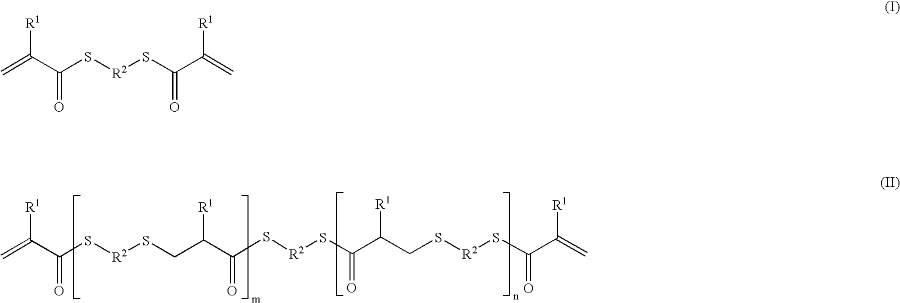

where each R¹, independently of the others, is hydrogen or a methyl radical,
each R², independently of the others, is a linear or branched, aliphatic or cycloaliphatic radical, or a substituted or unsubstituted aromatic or heteroaromatic radicals and each of m and n, independently of the others, is a whole number greater than or equal to 0, where m+n>>0,
with thiol compounds which encompass at least two thiol groups. This provides access to mixtures for preparing plastics, and also to coating compositions with excellent properties.

Another aspect of the present invention is mixtures encompassing
a) a prepolymer prepared from compounds of the formula (I) and/or (II)

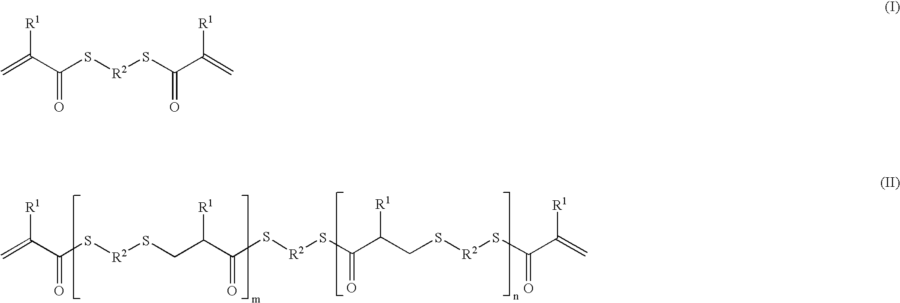

where each R¹, independently of the others, is hydrogen or a methyl radical,
each R², independently of the others, is a linear or branched, aliphatic or cycloaliphatic radical, or a substituted or unsubstituted aromatic or heteroaromatic radical, and each of m and n, independently of the others, is a whole number greater than or equal to 0, where m+n>0, and from alkyldithiols or from polythiols, preferably compounds of the formula (III),

HS—R³—SH (III)
where the definition of R³ can be identical to or different from the definition given in R²
b) at least one monomer (A) capable of free-radical polymerization and having at least 2 methacrylate groups and
c) aromatic vinyl compounds,
   these being suitable for preparing transparent plastics and having excellent mechanical and optical properties. The mixtures can, if appropriate, comprise
d) a monomer capable of free-radical polymerization and having at least two terminal olefinic groups whose reactivity differs, as is the case, for example, in a bifunctional monomer having a methacrylate end group and a vinyl end group, and/or
e) at east one ethylenically unsaturated monomer (B), preferably form the group of the methacrylates, particularly preferably 2-hydroxyethyl methacrylate.

The transparent plastics obtainable from the inventive thio(meth)acrylates have a previously unknown combination of exceptional properties, such as a high refractive index, a high Abbe number, good impact strength, and also high glass transition temperature. The corresponding plastics spectacle lenses exhibit low dispersion no colouring at the edges is observed.

The transparent plastics obtainable from the inventive thio(meth)acrylates simultaneously have other advantages. Among these are, inter alia:
[symbol] Since the inventive plastic has high refractive index, here is no requirement or reinforcement and therefore thickening of the centre and of the edges of corresponding plastics spectacle lenses, and there is a marked increase in the wearer comfort provided by these spectacles, due to the comparatively low weight.
[symbol] The very good impact strength of the inventive plastic protects the corresponding plastics spectacle lenses from the “everyday risks”. In particular in the case of thin spectacle lenses, it is very unlikely that mechanical forces will cause impairment or irreparable damage.
[symbol] The glass transition temperature of the inventive high-transparency plastic is high, preferably above 80.0° C., and up to this temperature the plastic therefore retains its exceptional mechanical properties, in particular high impact strength, and its hardness.
[symbol] The inventive high-transparency plastic can be prepared via free-radical copolymerization in a simple manner, or an industrial scale, at low cost, of a monomer mixture which is preferably flowable at atmospheric pressure and temperature in the range from 20.0 to 80.0° C.
[symbol] The underlying monomer mixture can likewise be prepared in a simple manner, on an industrial scales and at low cost.

The coating compositions obtainable from the thio(meth)acrylates, in particular for fibres, moreover exhibit excellent adhesion, and also excellent mechanical and optical properties.

The inventive thio(meth)acrylates are obtainable via reaction of compounds of the formula (I) and (II)

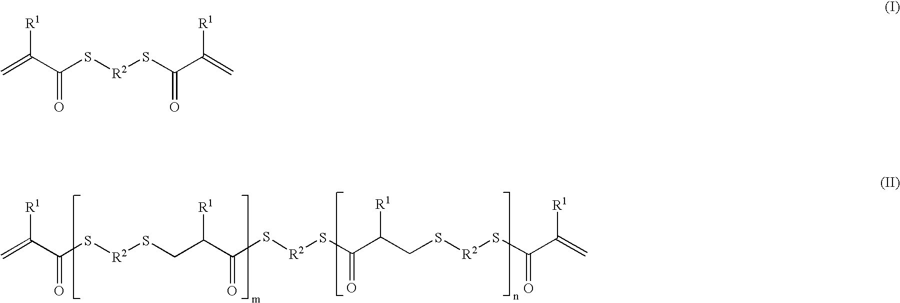

where each R¹, independently of the others, is hydrogen or a methyl radical,
each R², independently of the others, is a linear or branched, aliphatic or cycloaliphatic radical, or a substituted or unsubstituted aromatic or heteroaromatic radicals where the radical R² may preferably encompass 1 to 100, in particular 1 to 20, carbon atoms, and each of m and n, independently of the others, is a whole number greater than or equal to 0, where m+n>0.

Among the preferred linear or branched, aliphatic or cycloaliphatic radicals are, by way of example, the methylene, ethylene, propylene, isopropylene, n-butylene, isobutylene, tert-butylene or cyclohexylene group.

Among the preferred divalent aromatic or heteroaromatic radicals are in particular groups which derive from benzene, from naphthalene, from biphenyl, from diphenyl ether, from diphenylmethane, from diphenyldimethylmethane, from bisphenone, from diphenyl sulphone, from quinoline, from pyridine, from anthracene, and from phenanthrene. For the purposes of the present invention, cycloaliphatic radicals here also encompass bi-, tri- and polycyclic aliphatic radicals.

The radical R² also encompasses radicals of the formula

(—R⁴—X—)_{y}R⁵ (I-a),

where each R⁴ independently of the others, is a linear or branched, aliphatic or cycloaliphatic radical, e.g. a methylene, ethylene, propylene, isopropylene, n-butylene, isobutylene, tert-butylene or cyclohexylene group. Each radical X, independently of the others, is oxygen or sulphur, and the radical R⁵ is a linear or branched, aliphatic or cycloaliphatic radical, e.g. a methylene, ethylene, propylene, isopropylene, n-butylene, isobutylene, tert-butylene or cyclohexylene group. For the purposes of the present invention, cycloaliphatic radicals here also encompass bi-, tri- and polycyclic aliphatic radicals. y is a whole number from 1 to 10, in particular 1, 2, 3 or 4.

Preferred radicals of the formula (I-a) encompass:

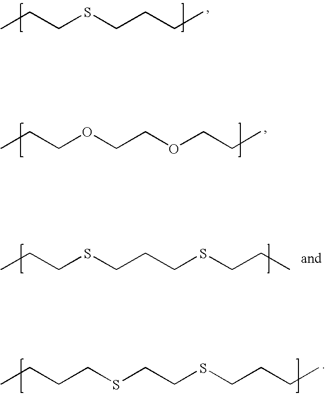

The radical R² is preferably an aliphatic radical having from 1 to 10 carbon atoms preferably a linear aliphatic radical having from 2 to 8 carbon atoms.

Each of the indices m and n, independently of the others, is a whole number greater than or equal to 0 such as 0, 1, 2, 3, 4, 5 or 6. The sum of m and n here is greater than 0, preferably in the range from 1 to 6, advantageously in the range from 1 to 4, in particular 1, 2 or 3.

Each of the compounds of the formula (I) and (II), and also the compounds of the formula (III), can be used individually or else in the form of a mixture of two or more compounds of the formula (I) and, respectively (II) for preparing the thio(methacrylate.

The relative proportions of the compounds of the formula (I) and (II) for preparing the inventive thio(meth)acrylates are in principle as desired, and they can be utilized in order to “tailor” the property profile of the inventive plastic according to the needs of the application. By way of example, it can be highly advantageous for the monomer mixture to comprise a marked excess of compound(s) of the formula (I) or compound(s) of the formula (II), in each case based on the total amount of compounds of the formula (I) and (II).

However, for the purposes of the present invention it is particularly advantageous for the mixture to comprise more than 10 mol %, preferably more than 12 mol %, in particular more than 14 mol % based on the total amount of the compounds of the formula (I) and (II), of compounds of the formula (II) where m+n=2. If R² is an ethylene radical, the proportion by weight of (II) where m+n=2 in the mixture is more than 10%, in particular more than 15%.

It is moreover particularly advantageous according to the invention to use mixtures which comprise more than 5.8 mol %, advantageously more than 6.5 mol %, in particular more than 7.5 mol %, based on the total amount of the compounds of the formula (I) and (III), of compounds of the formula (III where m+n=3. This corresponds to a proportion by weight of (II) of at least 6% if R² is an ethylene radical, where m+n=3.

The proportion of the compounds (I) is preferably from 0.1 to 50.0 mol %, advantageously from 10.0 to 45.0 mol %, in particular from 20.0 to 35.0 mol %, based on the total amount of the compounds of the formula (I) and (II), corresponding to a preferred range for the proportion by weight of the compound (I) of from 15 to 40% if R² is an ethylene radical. The proportion of the compounds (II) where m+n=1 is preferably from 1 to 40.0 mol %, advantageously from 5 to 35-0 mol %, in particular from 10 to 30 mol %, based on the total amount of the compounds of the formula (I) and (I). This corresponds to a preferred proportion by weight of the compounds (II) where m+n=1 of from 10 to 45% if R² is an ethylene radical. The proportion of the compounds (II) where m+n>3 is preferably greater than 0 mol % advantageously greater than 1 mol %, in particular greater than 2 mol %, based on the total amount of the compounds of the formula (I) and (II). If R² is an ethylene radical, the proportion by weight for compounds (II) where m+n>3 in the mixture is more than 2%, in particular more than 5%.

Processes for preparing the compounds of the formula (I) and (II) are known to the person skilled in the art by way of example from DE 4234251, the disclosure of which is expressly incorporated herein by way of reference. However, for the purposes of the present invention it has proven very particularly advantageous to prepare a mixture of the compounds of the formula (I) and (II) via a process in which from 10 to <2.0 mol, preferably from 1.1 to 1.8 mol, advantageously from 1.2 to 1.6 mol, in particular from 1.2 to 1.5 mot, of at least one compound of the formula (IX-a)

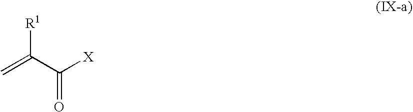

are reacted with one mole of at least one polythiol of the formula (IX-b)

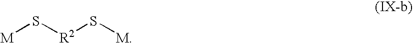

The radical X is halogen, in particular chlorine or bromine, or a radical

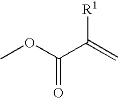

and this means that the compounds of the formula (IX-a) encompass inter alia acryloyl chloride, methacryloyl chloride, acrylic anhydride and methacrylic anhydride, particular preference being given to use of acrylic anhydride, methacrylic anhydride or a mixture of both.

Each M indicates, independently of the others, hydrogen or a metal cation. Preferred metal cations derive from elements whose electronegativity is smaller than 2.0, advantageously smaller than 1.5, particular preference being given to alkali metal cations, in particular Na⁺, K⁺, Rb⁺, Cs⁺ and alkaline earth metal cations, in particular Mg²⁺, Ca²⁺, Sr²⁺, Ba²⁺. Very particularly advantageous results may be achieved using the metal cations Na⁺ and K⁺.

Polythiols of the formula (IX-b) particularly suitable in this context encompass 1,2-ethanedithiol, 1,2-propanedithiol, 1,3-propanedithiol, 1,2-butanedithiol, 1,3-butanedithiol, 1,4-butanedithiol, 2-methylpropane-12-dithiol, 2-methylpropane-1,3-dithiol, 3,6-dioxa-1,8-octanedithiol (dimercaptodioxaoctane=DMDO), ethylcyclohexyl dimercaptans obtainable via reaction of 4-ethenylcyclohexene with hydrogen sulphide, ortho-bis(mercaptomethyl)benzene, meta-bis(mercapomethyl)benzene, para-bis(mercaptomethyl)benzene, the following compounds of the formula (IX-b):

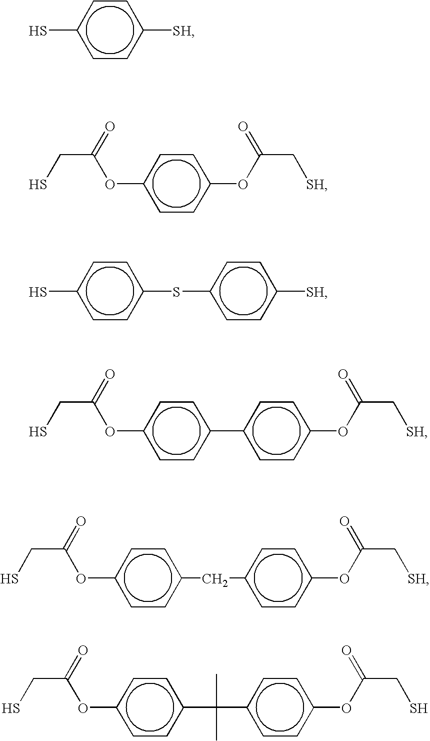

and also compounds of the formula

HSR⁴—X—)_{y}R⁵SH (IX-c)

where each R⁴, independently of the others, is a linear or branched, aliphatic or cycloaliphatic radical; such as a methylene, ethylene, propylene, isopropylene, n-butylene, isobutylene, tert-butylene or cyclohexylene group. For the purposes of the present invention, cycloaliphatic radicals here also encompass bi-, tri- and polycyclic aliphatic radicals. Each radical X, independently of the others, is oxygen or sulphur, and the radical R⁵ is a linear or branched, aliphatic or cycloaliphatic radical, such as a methylene, ethylene, propylene, isopropylene, n-butylene, isobutylene, tert-butylene or cyclohexylene group. For the purposes of the present invention, cycloaliphatic radicals here also encompass bi-, tri- and polycyclic aliphatic radicals. y is a whole number from 1 to 10, in particular 1, 2, 3 or 4.

Preferred compounds of the formula (IX-c) encompass:

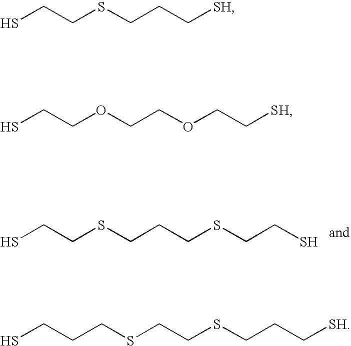

For the purposes of one very particularly preferred embodiment of this process, the compound used of the formula (IX-b) comprises 1,2-ethanedithiol.

According to this process, the (meth)acrylates of the formula (IX-a) in a least one inert, organic solvent S and the polythiols of the formula (IX-b) are reacted aqueous alkaline solution, the term “inert, organic solvent” meaning those organic solvents which do not react with the compounds present in the reaction system under the respective reaction conditions.

It is preferable for at least one solvent S to have a relative dielectric constant >2.6, preferably >3.0, advantageously >4.0, in particular >5.0, each case measured at 20° C. In this context, the relative dielectric constant indicates a dimensionless value stating the factor by which the capacitance C of a (theoretical) capacitor located within a vacuum increases when substances with dielectric properties, known as dielectrics, are introduced between the plates. This value is measured at 20° C. and extrapolated to low frequencies (φ→0). For further details reference is made to the familiar technical literature, in particular to Ullmann Encyklopadie der technischen Chemie, [Ullmann's Encyclopaedia of Industrial Chemistry] Volume 2/1 Anwendung physikalischer und physikalisch-chemischer Methoden im Laboratorium [Application of physical and physico-chemical methods in the laboratory], headword: Dielektrizitätskonstante [Dielectric constant], pp. 455-479. Dielectric values of solvents are given, inter alia, in Handbook of Chemistry and Physics, 71st edition, CRC Press, Baco Raton, Ann Arbor, Boston, 1990-1991, pp. 8-44, 8-46 and 9-9 to 9-12.

For the purposes of this process it is moreover particularly advantageous for the solvent and the aqueous solution to form two phases during the reaction and not to be capable of homogeneous mixing. To this end, the water solubility value for the solvent, measured at 20° C., is preferably smaller than 10 g of water, based on 100 g of solvent.

Solvents S preferred according to the invention encompass

aliphatic ethers, such as diethyl ether (4.335), dipropyl ether, diisopropyl ether;
cycloaliphatic ethers, such, as tetrahydrofuran (7.6);
aliphatic esters, such as methyl formate (8.5), ethyl formate, propyl formate, methyl acetate, ethyl acetate, n-butyl acetate (5.01) methyl propionate, methyl butyrate (5.6), ethyl butyrate, 2-methoxyethyl acetate;
aromatic esters, such as benzyl acetate, dimethyl phthalate, methyl benzoate (6.59), ethyl benzoate (6.02), methyl salicylate, ethyl salicylate, phenyl acetate (523);
aliphatic ketones, such as acetone, methyl ethyl ketone (18.5), 2-pentanone (15.4), 3-pentanone (17.0), methyl isoamyl ketone, methyl isobutyl ketone (13.1);
aromatic ketones, such as acetophenone;
nitroaromatics, such as nitrobenzene, o-nitrotoluene (27.4), m-nitrotoluene (23), p-nitrotoluene;
halogenated aromatics, such as chlorobenzene (5.708), o-chlorotoluene (4-45)ᵣ m-chlorotoluene (5.55), p-chlorotoluene (6.08), o-dichlorobenzene, m-dichlorobenzene;
heteroaromatics, such as pyridine, 2-methylpyridine 9.8), quinoline, isoquinoline; and mixtures of these compounds, the data in brackets being the respective associated relative dielectric constants at 20° C.

Compounds very particularly suitable here for the purposes of the present process are aliphatic esters and cycloaliphatic ethers, in particular ethyl acetate and tetrahydrofuran.

For the purposes of the present process, it is possible either to use the solvent S alone or else to use a solvent mixture, in which case it is not necessary that all of the solvents present in the mixture comply with the abovementioned dielectric criterion. By way of example, according to the invention it is also possible to use tetrahydrofuran/cyclohexane mixtures. However, it has proven advantageous four the solvent mixture to have a relative dielectric constant >2.6, preferably >3.0, advantageously >4.0, in particular >5.0, in each case measured at 20° C. Particularly advantageous results can be achieved using solvent mixtures which comprise only solvents whose relative dielectric constant is >2.6, preferably >3.0, advantageously >4.0, in particular >5.0, in each case measured at 20° C.

The aqueous alkaline solution of the compound(s) of the formula (IX-b) preferably comprises from 1.1 to 1.5 val (equivalents) of at least one Bronsted base, based on the total amount of compound(s) of the formula (IX-b). Preferred Bronsted bases for the purposes of the present invention encompass alkali metal hydroxides and alkaline earth metal hydroxides in particular sodium hydroxide and potassium hydroxide

In principle, any conceivable method may be used for the conduct of the reaction. By way of example, the compound(s) of the formula (IX-a) may form an initial charge in the solvent (mixture, S, and the aqueous alkaline solution of the compound(s) of the formula (IX-b) may be added stepwise or continuously. However, for the purposes of the present process it has proven very particularly advantageous to meter the compound(s) of the formula (IX-a) in at least one inert, organic solvent S and the compound(s) of the formula (IX-b) in aqueous alkaline solution to the reaction vessel in parallel.

The reaction temperature may be varied widely, but the temperature is often in the range from 20.0 to 120.0° C., preferably in the range from 20.0 to 8.0° C. Similar considerations apply for the pressure at which the reaction is completed. The reaction may therefore take place either at subatmospheric pressure or else at superatmospheric pressure. However, it is preferably carried out at atmospheric pressure. Although the reaction can also take place in air, it has proven very particularly advantageous for the purposes of the present process to carry out the reaction under an inert gas, preferably nitrogen and/or argon, preferably with a very small proportion of oxygen present.

The reaction mixture a advantageous reacted in a further step with a Bronsted acid, preferably until the pH of the aqueous solution at 20° C. is below 7.0, advantageously below 6.0, in particular below 5.0. Acids which may be used in this context encompass inorganic mineral acids, such as hydrochloric acid, sulphuric acid, phosphoric acid, organic acids, such as acetic acid, propionic acid, and acidic ion exchangers, in particular acidic synthetic resin ion exchangers, e.g. ®Dowex M-31 (H). The method which has proven very particularly successful here is the use of acidic synthetic resin ion exchangers loaded with at least 1.0 meq, preferably a least 2.0 meq in particular at least 4.0 meld of H+ ions, based on 1 g of dry ion exchanger, grain sizes of from 10 to 50 mesh and porosities in the range from 10 to 52% based on the total volume of the ion exchanger.

In an advantageous method for isolating the compounds of the formula (I) and (II) the organic phase composed of the solvent S is separated off and, where appropriates washed, and dried and the solvent is evaporated.

During the reaction of the compound(s) of the formula (IX-a) with the compound(s) of the formula (IX-b) it is possible to add inhibitors which inhibit free-radical polymerization of the (meth)acrylic groups during the reaction. These inhibitors are well known to persons skilled in the art.

Use is mainly made of 1,4-dihydroxybenzenes. However, it is also possible to use dihydroxybenzenes having other substitution. These inhibitors can generally be represented by the general formula (X)

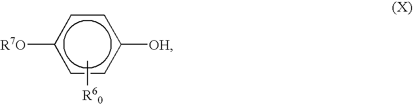

where
R⁶ is a linear or branched alkyl radical having from one to eight carbon atoms, halogen or aryl, preferably an alkyl radical having from one to four carbon atoms, particularly preferably methyl, ethyl, n-propyl, isopropyl, n-butyl, isobutyl, sec-butyl, tert-butyl, Cl, F or Br;
o is a whole number in the range from one to four, preferably one or two; and
R⁷ is hydrogen, a linear or branched alkyl radical having from one to eight carbon atoms, or aryl, preferably an alkyl radical having from one to four carbon atoms, particularly preferably methyl, ethyl, n-propyl, isopropyl, n-butyl, isobutyl, sec-butyl or tert-butyl.

However, it is also possible to use compounds whose parent compound is 1,4-benzoquinone. These may be described by the formula (XI)

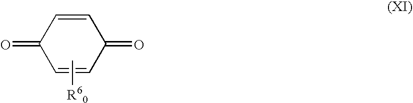

where R⁶ and o are defined as above.

Phenols of the general structure (XII) are also used

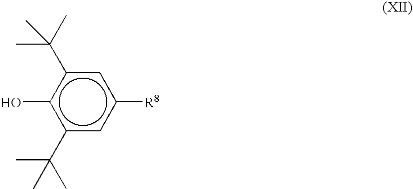

where
R⁸ is a linear or branched alkyl radical having from one to eight carbon atoms, aryl or aralkyl, propionic esters with mono- to tetrahydric alcohols, which may also contain heteroatoms, such as S, O and N, preferably an alkyl radical having from one to four carbon atoms, particularly preferably methyl, ethyl, n-propyl, isopropyl, n-butyl, isobutyl, sec-butyl, tert-butyl.

Another advantageous class of substances is provided by hindered phenols based on triazine derivatives of the formula (XIII)

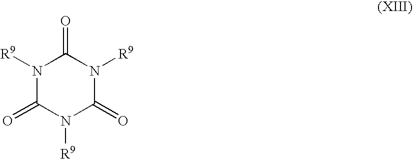

where R⁹=compound of the formula (XIV)

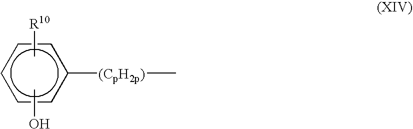

where

R¹⁰=CₚH₂ₚ₊₁

where p=1 or 2.

Compounds used with particular success are 1,4-dihydroxybenzene, 4-methoxyphenol, 2,5-dichloro-3,6-dihydroxy-1,4-benzoquinone, 1,3,5-trimethyl-2,4,6-tris(3,5-di-tert-butyl-4-hydroxybenzyl)benzene, 2,6-di-tert-butyl-4-methylphenol, 2,4-dimethyl-6-tert-butylphenol, 2,2-bis[3,5-bis 41-dimethylethyl)-4-hydroxyphenyl-1-oxopropoxymethyl)]1,3-propanediyl ester, 2,2′-thiodiethyl bis[3-3,5-di-tert-butyl-4-hydroxyphenyl)]propionate, octadecyl 3-(3,5-di-tert-butyl-4-hydroxyphenyl)propionate, 3,5-bis(1,1-dimethylethyl-2,2-methylenebis(4-methyl-6-tert-butyl)phenol, tris(4-tert-butyl-3-hydroxy-2,6-dimethylbenzyl)-s-triazine-2,4,6-(1H,3H,5H)trione, tris(3,5-di-tert-butyl-4-hydroxy)-s-triazine-2,4,6-(1H,3H,5H)-trione or tert-butyl-3,5-dihydroxybenzene.

Based on the weight of the entire reaction mixture, the proportion of the inhibitors individually or in the form of a mixture is generally from 0.01 to 0.50% (by weight), the concentration of the inhibitors preferably being selected in such a way as not to impair the DIN 55945 colour number. Many of these inhibitors are commercially available.

The mixture obtained in preparing the compounds according to the formulae (I) and/or (II) can be worked up according to processes of the prior art. By way of example, the different compounds of the formulae (I) and/or (II) can be separated. Residues and/or impurities can moreover be removed.

The resultant compounds of the formula (I) and/or (II) can then be reacted with thiol compounds which encompass at least two thiol groups, to give the inventive thio(meth)acrylates.

Furthermore, the reaction mixture obtained in the reaction can be used without work-up for the preparation of the thio(meth)acrylates of the invention.

For this, thiol compounds which encompass at least two thiol groups can be added to the reaction mixture. The addition preferably takes place after a major portion of the compounds of the formulae (I-a) have been reacted with the compounds of the formulae (IX) to give compounds of the formulae (I) and/or (II). The conversion of the compounds of the formulae (I-a) on addition of the thiol compounds which encompass at least two thiol groups is preferably at least 50%, particularly preferably at least 80% and very particularly preferably at least 95%. The conversion here is preferably calculated from the compounds of the formula (I-a) present in the reaction mixture on addition of further thiol compounds which encompass at least two thiol groups, based on the initial content of these used. This content can by way of example be determined via chromatographic methods, in particular GCMS, and a standard may be present here.

The thiol compounds which are used for preparing the inventive thio(meth)acrylates and which encompass at least two thiol groups are known per se. Among these are in particular alkyldithiols, and also polythiols. Among the thiol compounds are also thiolates which are produced by reaction between a base and compounds encompassing S—H groups.

Preferred thiol compounds which encompass at least two thiol groups are compounds of the formula (III-a)

MS-R³-SM (III-a)

where R³ is a linear or branched, aliphatic or cycloaliphatic radical or a substituted or unsubstituted aromatic or heteroaromatic radical and each M, independently of the others, is hydrogen, an ammonium ion or a metal cation.

Preferred metal cations derive from elements whose electronegativity is smaller than 2.0, advantageously smaller than 1.5, particular preference being given to alkali metal cations in particular Na⁺, K⁺, R⁺, Cs⁺ and alkaline earth metal cations, in particular Mg²⁺, Ca²⁺, Sr²⁺, Ba²⁺. Very particularly advantageous results may be achieved using the metal cations Na⁺ and K⁺.

The radical R³ also encompasses radicals of the formula

(—R⁴—X—)_{y}R⁵ (III-b),

where each R⁴, independently of the others, is a linear or branched, aliphatic or cycloaliphatic radical, such as a methylene, ethylene, propylene, isopropylene, n-butylene, isobutylene, tert-butylene or cyclohexylene group. Each radical X, independently of the others, is oxygen or sulphur, and the radical R⁵ is a linear or branched, aliphatic or cycloaliphatic radical, such as a methylene, ethylene, propylene, isopropylene, n-butylene, isobutylene, tert-butylene or cyclohexylene group. For the purposes of the present invention, cycloaliphatic radicals here also encompass bi-, tri- and polycyclic aliphatic radicals. y is a whole number from 1 to 10, in particular 1, 2, 3 or 4.

Preferred radicals of the formula (III-b) encompass.

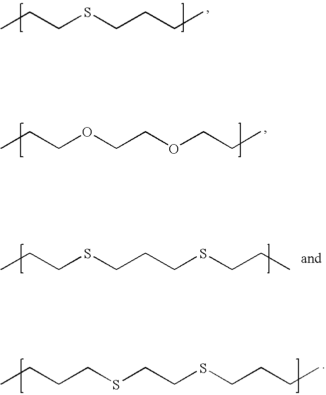

The radical R³ is preferably an aliphatic radical having from 1 to 10 carbon atoms, preferably a linear aliphatic radical having from 2 to 8 carbon atoms.

Each of the indices m and n is, independently of the others, a whole number greater than or equal to 0, such as 0, 1, 2, 3, 4, 5 or 6. The sum of m and n here is greater than 0 preferably in the range from 1 to 6, advantageously in the range from 1 to 4, in particular 1, 2 or 3.

Polythiols of the formula (III) and, respectively, (III-a) particularly suitable in this context encompass 1,2-ethanedithiol, 1,2-propanedithiol, 1,3-propanedithiol, 1,2-butanedithiol, 1,3-butanedithiol, 1,4-butanedithiol, 2-methylpropane-1,2-dithiol, 2-methylpropane-1,3-dithiol, 3,6-dioxa-1,8-octanedithiol (dimercaptodioxaoctane=DMDO), ethylcyclohexyl dimercaptans obtainable via reaction of 4-ethenylcyclohexene with hydrogen sulphide, ortho-bis(mercaptomethyl)benzene, meta-bis(mercaptomethyl)benzene, para-bis(mercaptomethyl)benzene, the following compounds of the formula (III):

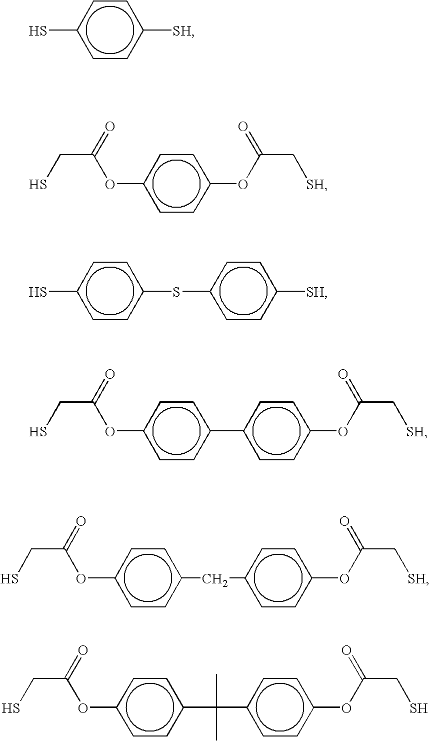

and also compounds of the formula

HS(—R⁴—X—)_{y}R⁵SH (III-c),

where each R⁴, independently of the others, is a linear or branched, aliphatic or cycloaliphatic radical, such as a methylene, ethylene, propylene, isopropylene, n-butylene, isobutylene, tert-butylene or cyclohexylene group. For the purposes of the present invention, cycloaliphatic radicals here also encompass bi-, tri- and polycyclic aliphatic radicals. Each radical X, independently of the others, is oxygen or sulphur, and the radical R⁵ is a linear or branched, aliphatic or cycloaliphatic radical, such as a methylene, ethylene, propylene, isopropylene, n-butylene, isobutylene, tert-butylene or cyclohexylene group. For the purposes of the present invention, cycloaliphatic radicals here also encompass bi-, tri- and polycyclic aliphatic radicals. y is a whole number from 1 to 10, in particular 1, 2, 3 or 4.

Preferred compounds of the formula (III-c) encompass:

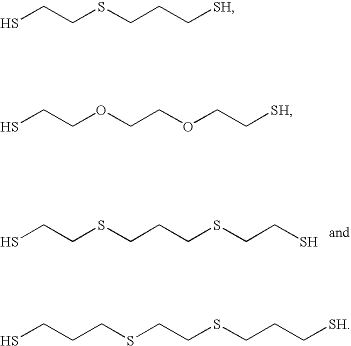

For the purposes of one very particularly preferred embodiment of this process, the compound used of the formula (III) and, respectively, (III-a) comprises 1,2-ethanedithiol.

The reaction of the compounds according to formula (I) and/or (II) with the thiol compounds which encompass at least two thiol groups can take place under the conditions described above for preparing the compounds according to the formulae (I) and/or (II), in particular from the compounds of the formulae (IX-a) and (IX-b).

Accordingly, the compounds of the formulae (I) and/or (II) in at least one inert, organic solvent S and the thiol compounds which encompass at least two thiol groups in particular the compound(s) of the formulae (III) and, respectively, (III-a), can be reacted in aqueous-alkaline solution, the term “inert, organic solvent” here meaning those organic solvents which do not react with the compounds present in the reaction system under the respective reaction conditions.

It is preferable for at least one solvent S to have a relative dielectric constant >2.6, preferably >3.0, advantageously >4.0, in particular >5.0 in each case measured at 20° C.

For the purposes of this process it is moreover particularly advantageous for the solvent and the aqueous solution to form two phases during the reaction and not to be capable of homogeneous mixing. To this end, the water solubility value for the solvent, measured at 20° C., is preferably smaller than 10 g of water, based on 100 g of solvent.

For the purposes of the present process it is possible either to use the solvent S alone or else to use a solvent mixture, in which case it is not necessary that all of the solvents present in the mixture comply with the abovementioned dielectric criterion. By way of example, according to the invention it is also possible to use tetrahydrofuran/cyclohexane mixtures. However, it has proven advantageous for the solvent mixture to have a relative dielectric constant >2.6, preferably >3.0, advantageously >4.0, in particular >5.0, in each case measured at 20° C. Particularly advantageous results can be achieved using solvent mixtures which comprise only solvents whose relative dielectric constant is >2.6, preferably >3.0, advantageously >4.0, in particular >5.0, in each case measured at 20° C.

The aqueous alkaline solution of the thiol compounds, in particular compound(s) of the formula and, respectively (III-a), preferably comprises 1.1 to 1.5 eq (equivalents) of at least one Bronsted base, base on the total amount of thiol compounds. For the purposes of the present invention, preferred Bronsted bases encompass alkali metal hydroxides and alkaline earth metal hydroxides, in particular sodium hydroxide and potassium hydroxide.

According to one particular aspect of the present invention, the molar ratio of compounds of the formula (I) and/or (II) to the thiol compound encompassing at least two thiol groups can be in the range from 50:1 to 1:2, preferably from 30:1 to 2:1.

In principle, the reaction can be carried out in any conceivable manner, and by way of example it is possible for the compound(s) of the formula (I) and/or (II) in the solvent (mixture) S to form an initial charge, and for the aqueous alkaline solution of the thiol compounds, in particular compound(s) of the formula (III) and, respectively, (III-a) to be added stepwise or continuously. However, for the purposes of the present process it has proven very particularly advantageous for the compound(s) of the formulae (I) and/or (II) in at least one inert, organic solvent S and the thiol compounds, in particular compound(s) of the formula (III) and, respectively, (III-a) in aqueous alkaline solution to be metered in parallel into the reaction vessel.

The reaction temperature may be varied widely, but the temperature is often in the range from 20.0 to 120.0° C., preferably in the range from 20.0 to 80.0° C. Similar considerations apply for the pressure at which the reaction is completed. The reaction may therefore take place either at subatmospheric pressure or else at superatmospheric pressure. However, it is preferably carried out at atmospheric pressure. Although the reaction can also take place in air, it has proven very particularly advantageous for the purposes of the present process to carry out the reaction under an inert gasp preferably nitrogen and/or argon, preferably with a very small proportion of oxygen present.

The reaction mixture is advantageously reacted n a further step with a Bronsted acid, preferably until the pH of the aqueous solution at 20° C. is below 7.0, advantageously below 6.0, in particular below 5.0. Acids which may be used in this context encompass inorganic mineral acids, such as hydrochloric acid, sulphuric acid, phosphoric acid, organic acids, such as acetic acid, propionic acid, and acidic ion exchangers, in particular acidic synthetic resin ion exchangers, e.g. ®Dowex M-31 (H). The method which has proven very particularly successful here is the use of acidic synthetic resin ion exchangers loaded with at least 1.0 meq, preferably at least 2.0 meq, in particular at least 4.0 meq, of H+ ions, based on 1 g of dry ion exchangers grain sizes of from 10 to 50 mesh and porosities in the range from 10 to 50%, based on the total volume of the ion exchanger.

In order to isolate the inventive thio(meth)acrylates, the organic phase composed of the solvent S can advantageously be separated off, and if appropriate washed and dried, and the solvent evaporated.

The other reaction conditions have been described above, and in particular inhibitors can be used here

It can be assumed that the reaction forms thio(meth)acrylates encompassing compounds of the formulae

A-Y-A (IV-a)

and/or

A-Y-Z-B (IV-b)

and/or

A-(Z-Y)_{q}-Y-A (IV-c)

and/or

B-(Z-Y)ᵣ-Z-B (IV-d)

and/or

A-(Y-Z)ₛ-B (IV-e)

where q, r and s are whole numbers in the range from 1 to 100, preferably 2 to 30 and more preferably 3 to 10,
A is an end group of the formulae

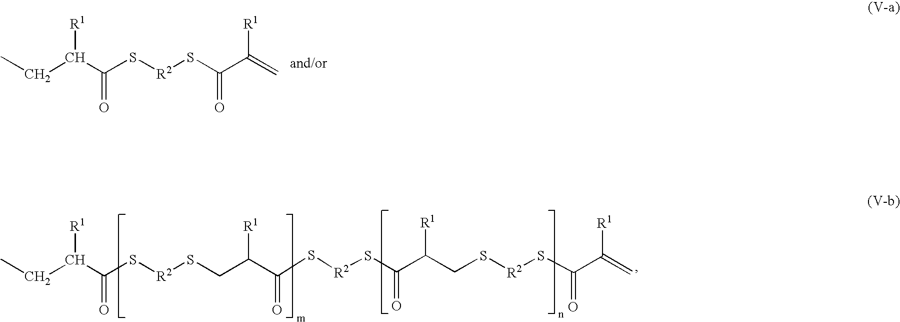

B is an end group of the formula

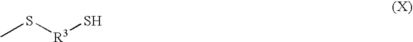

Z is a connecting group of the formulae

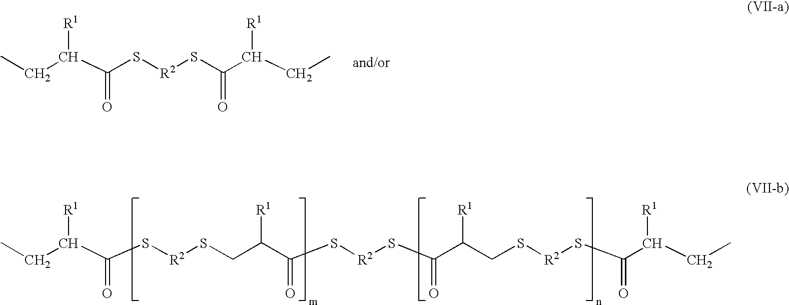

Y is a connecting group of the formulae

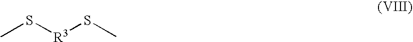

where
each R¹, independently of the others, is hydrogen or a methyl radical,
each R², independently of the others, is a near or branched, aliphatic or cycloaliphatic radical or a substituted or unsubstituted aromatic or heteroaromatic radical, and each of m an n, independently of the others, is a whole number greater than or equal to 0, where m+n>0, and
R³ is a linear or branched, aliphatic or cycloaliphatic radical or a substituted or unsubstituted aromatic or heteroaromatic radical.

The weight-average molecular weight of the inventive thio(meth)acrylates can preferably be in the range from 300 to 5000 Da, in particular in the range from 500 to 2000 Da. The weight-average molecular weight can be determined by GPC or HPLC.

The viscosity of the thio(meth)acrylate (undiluted, determined to DIN 53019) determined at 25° C. can be in the range from 100 to 1000 mPa·s, particularly preferably in the range from 200 to 600 mPa·s.

The molecular weight, and also the viscosity, can be adjusted via selection of the radicals R² and R³. Furthermore, these variables can be the result of the molar ratio of compounds of the formulae (I) and/or (II) to the thiol compounds, in particular according to the formulae (III) and, respectively, (III-a).

According to one particular aspect of the present invention, the ratio of compounds of the formula (IV-b), (IV-d) and (IV-e) to compounds of the formula (IV-a) and (IV-c) is very small, since the conversion in the addition reaction of thiol to the methacrylic double bond is complete. The content of compounds having thiol groups is preferably <5%, in particular <1%. The conversion of the thiol group can be followed by means of IR spectroscopy.

Among the preferred thiomethacrylates of the present invention are inter alia compounds of the formula

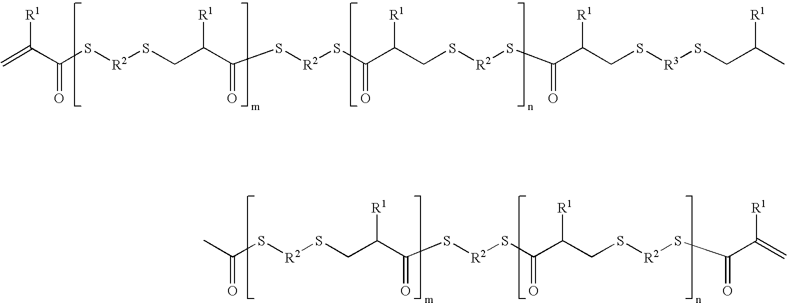

where the radicals R¹, R² and R³ are defined as above and each of the indices m and n, independently of the others, is a whole number greater than or equal to 0.

Particularly preferred thio(meth)acrylates of the present invention can be regarded as prepolymers.

The prepolymer of the present invention can encompass compounds of the formula (I) and/or (II) and (III)

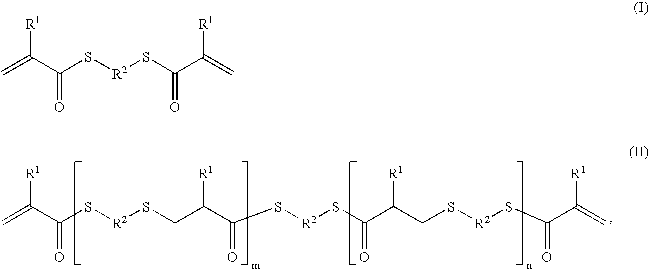

HS—R³—SH (III),

where each R¹, independently of the others, is hydrogen or a methyl radical, preferably a methyl radical, and each R², independently of the others, is a linear or branched, aliphatic or cycloaliphatic radical, or a substituted or unsubstituted aromatic or heteroaromatic radical, where the radical R² may preferably encompass from 1 to 100, in particular from 1 to 20, carbon atoms and
each radical R³, irrespective of R², is a linear or branched, aliphatic or cycloaliphatic radical or a substituted or unsubstituted aromatic or heteroaromatic radical, where the radical R³ can preferably encompass from 1 to 100, in particular from 1 to 20, carbon atoms.

Each of the compounds of the formula (I) and (II), and also the compounds of the formula (III), can be used individually or else in the form of a mixture of two or more compounds of the formula (I), (II) and, respectively, (III) for preparing the prepolymer. The relative contents of the compounds of the formula (I), (II) and (III) in the inventive monomer mixture are in principle as desired, and they can be utilized to “tailor” the property profile of the inventive plastic in accordance with needs. By way of example, it can be highly advantageous for the monomer mixture to comprise a marked excess of compound(s) of the formula (I) or compound's of the formula (II) or compound(s) of the formula (III), in each case based on the total amount of compounds of the formula (I), (II) and (III) in the prepolymer.

The content of compounds (III) in the prepolymer is preferably from 1 to 55.0 mol %, in particular from 10.0 to 50.0 mol %, based on the total amount of the compounds of the formula (I), (II) and (III). If in a specific instance R³ is a dimercaptodioxaoctane radical, the proportion by weight of (III) in the prepolymer, based on the total amount of the compounds (I), (II) and (III) is more than 0.5%, preferably more than 5%.

The inventive thio(meth)acrylates can be polymerized to give plastics which in particular can serve for producing lenses. In order to modify properties, the inventive thio(meth)acrylates can be mixed with other monomers.

For the purposes of the present invention, a preferred mixture or preparing plastics can comprise not only thio(meth)acrylates, preferably in the form of a prepolymer, prepared from compounds of the formula (I), (II) and (III) but also at least one monomer (A) capable of free-radical polymerization and having at least two terminal methacrylate groups.

Examples of these di(meth)acrylates are polyoxymethylene(meth)acrylic acid derivatives and polyoxypropylene(meth)acrylic acid derivatives, e.g. triethylene glycol (meth)acrylate, tetraethylene glycol (meth)acrylate, tetrapropylene glycol (meth)acrylate and also 1,4-butanediol di(meth)acrylate, diethylene glycol di(meth)acrylate, dipropylene glycol di(meth)acrylate, triethylene glycol di(meth)acrylate, tripropylene glycol di (meth)acrylate, tetraethylene glycol di(meth)acrylate, tetrapropylene glycol di(meth)acrylate, polyethylene glycol di(meth)acrylate (preferably having weight-average molar masses in the range from 200 to 5 000 000 g/mol, advantageously in the range from 200 to 25 000 g/mol, in particular in the range from 200 to 1000 g/mol), polypropylene glycol di(meth)acrylate (preferably with weight-average molar masses in the range from 200 to 5 000 000 g/mol, advantageously in the range from 250 to 4000 g/mol, in particular in the range from 250 to 1000 g/mol), 2,2′-thiodiethanol di (meth)acrylate thiodiglycol di(meth)acrylate),

3,9-di(meth)acryloyloxymethyltricyclo[5.2.1.0(2.6)]-decane, in particular

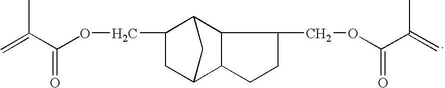

3,8-di(meth)acryloyloxymethyltrioyclo[5.2.1.0(2.6)]-decane,
4,8-di(meth)acrylovloxymethyltricyclo[5.2.1.0(2.6)]-decane,
4,9-di(meth)acryloxymethyltricyclo[5.2.1.0(2.6)]-decane, ethoxylated bisphenol A di(meth)acrylate, in particular

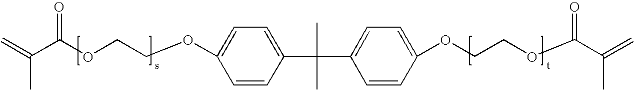

where s and t are greater than or equal to zero, and the sum of s and t is preferably in the range from 1 to 30, in particular in the range from 2 to 10, and di(meth)acrylates obtainable via reaction of diisocyanates with 2 equivalents of hydroxyalkyl (meth)acrylate, in particular

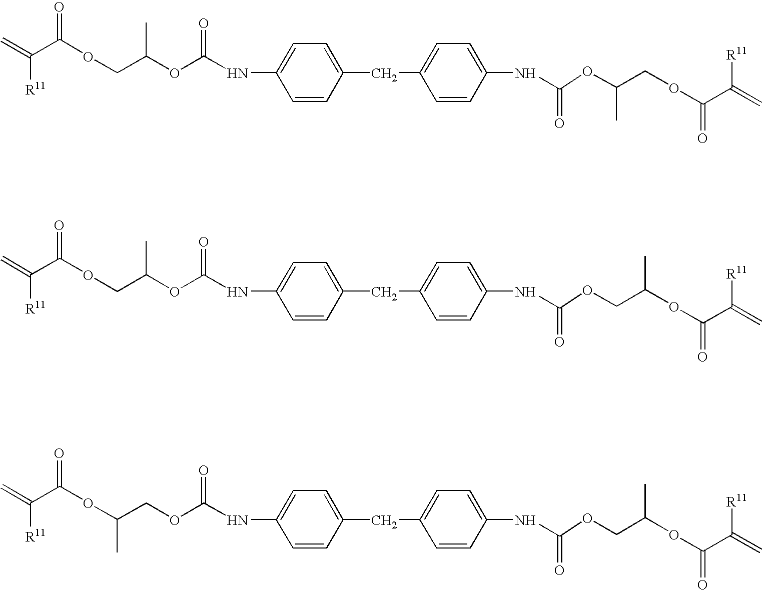

where each radical R¹¹, independently of the others, is hydrogen or a methyl radical,
tri(meth)acrylates, such as trimethylolpropane tri(meth)acrylate and glycerol tri (meth)acrylate, or else (meth)acrylates of ethoxylated or propoxylated glycerol, of trimethylolpropane, or of other alcohols having more than 2 hydroxy groups.

Di(meth)acrylates of the formula (XV)

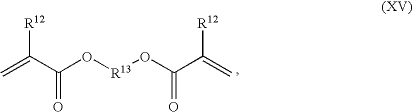

have proven particularly successful as monomer (A). Each R¹² here, independently of the others, is hydrogen or methyl. R¹³ indicates a linear or branched alkyl or cycloalkyl radical, or an aromatic radical preferably having from 1 to 100, with reference from 1 to 40, preferably from 1 to 20, advantageously from 1 to 8, in particular from 1 to 6, carbon atoms, e.g. a methyl, ethyl, propyl, isopropyl, n-butyl, isobutyl, tert-butyl, cyclopentyl, cyclohexyl, or phenyl group. For the purposes of the present invention, cycloaliphatic radicals here also encompass bi-, tri-, and polycyclic aliphatic radicals. Linear or branched alkyl or cycloalkyl radicals having from 1 to 6 carbon atoms are very particularly preferred as R¹⁸.

The radical R¹³ is preferably a linear or branched, aliphatic or cycloaliphatic radical, such as a methylene, ethylene, propylene, isopropylene, n-butylene, isobutylene, tert-butylene or cyclohexylene group, or a radical of the general formula

(—R¹⁴—X^{I})_{z}R¹⁵, (XVa)

where the radical R¹⁵ is a linear or branched, aliphatic or cycloaliphatic radical, or a substituted or unsubstituted aromatic or heteroaromatic radical, e.g. a methylene, ethylene, propylene, isopropylene, n-butylene, isobutylene, tert-butylene or cyclohexylene group, or divalent aromatic or heteroaromatic groups which derive from benzene, from naphthalene, from biphenyl, from diphenyl ether, from diphenylmethane, from diphenyldimethylmethane, from bisphenone, from diphenyl sulphone, from quinoline, from pyridine, from anthracene, or from phenanthrene. For the purposes of the present invention, cycloaliphatic radicals here also encompass bi-, tri- and polycyclic aliphatic radicals. Each radical R¹⁴, independently of the others, is a linear or branched, aliphatic or cycloaliphatic radical or a substituted or unsubstituted aromatic or heteroaromatic radical, e.g. a methylene, ethylene, propylene, isopropylene, n-butylene, isobutylene, tert-butylene or cyclohexylene group, or divalent aromatic or heteroaromatic groups which derive from benzene, from naphthalene, from biphenyl, from diphenyl ether, from diphenylethane, from diphenyldimethylmethane, from bisphenone, from diphenyl sulphone, from quinoline, from pyridine, from anthracene, or from phenanthrene. For the purposes of the present invention, cycloaliphatic radicals here also encompass bi-, tri- and polycyclic aliphatic radicals. Each radical X^{I}, independently of the others, is oxygen, sulphur, a ester group of the genera formula (XVb), (XVc),

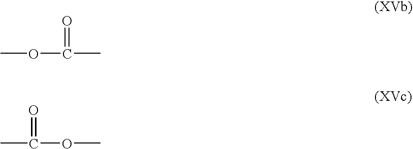

a urethane group of the general formula (XVd), (XVe), (XVf) or (XVg),

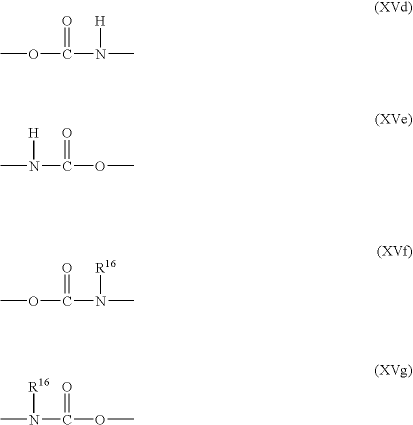

a thiourethane group of the general formula (XVh), (XVi), (XVj) or (XVk),

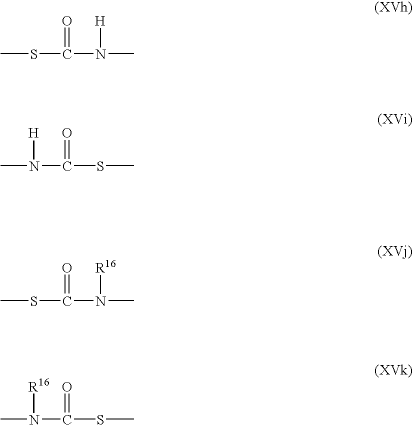

a dithiourethane group of the general formula (XVl), (XVm), (XVn) or (XVo)

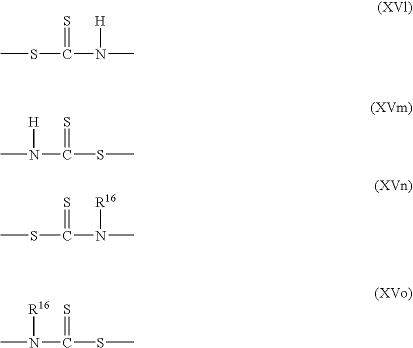

or a thiocarbamate group of the general formula (XVp), (XVq), (XVr) or (XVs)

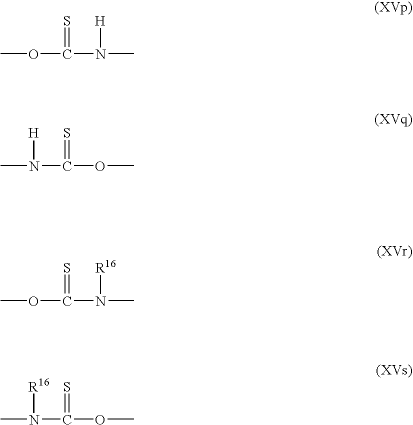

preferably oxygen, where the radical R¹⁶ is a linear or branched, aliphatic or cycloaliphatic radical or a substituted or unsubstituted aromatic or heteroaromatic radical, e.g. a methyl, ethyl, propyl, isopropyl, n-butyl, isobutyl, tert-butyl or cyclohexyl group, or monovalent aromatic or heteroaromatic groups derived from benzene, from naphthalene, from biphenyl, from diphenyl ether, from diphenylmethane, from diphenyldimethylmethane, from bisphenone, from diphenyl sulphone, from quinoline, from pyridine, from anthracene, or from phenanthrene. For the purposes of the present invention, cycloaliphatic radicals here also encompass bi-, tri- and polycyclic aliphatic radicals. z is a whole number from 1 to 1000, advantageously from 1 to 100, in particular from 1 to 25.

Particularly preferred di(meth)acrylates of the formula (XV) encompass ethylene glycol di(meth)acrylate, ethoxylated bisphenol A di(meth)acrylate, in particular

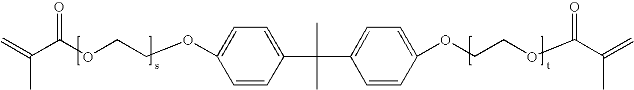

where s and t are greater than or equal to zero and the sum of s and t is preferably in the range from 1 to 30, in particular in the range from 2 to 10, and di(meth)acrylates obtainable via reaction of diisocyanates with 2 equivalents of hydroxyalkyl (meth)acrylate, in particular

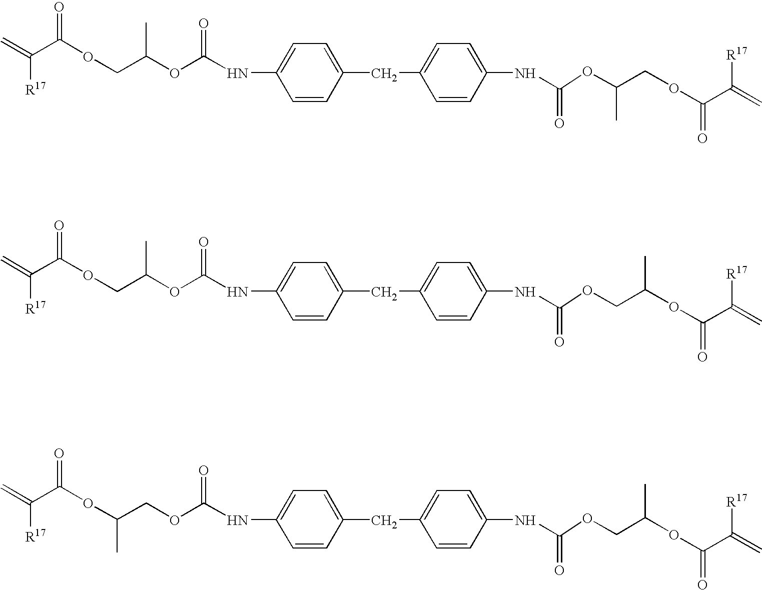

where each radical R¹⁷, independently of the others, is hydrogen or a methyl radical,
3,8-di(meth)acryloyloxymethyltricyclo[5.2.1.0(2.6)]-decane,
3,9-di(math)acryloyloxymethyltricyclo[5.2.1.0(2.6)]-decane,
4,8-di(meth)acryloyloxymethyltricyclo[5.2.1.0(2.6)]-decane,
4,9-di(meth)acryloylcxymethyltricyclo[5.2.1.0(2.6)]-decane,
   thiodiglycol di(meth)acrylate, polypropylene glycol di(meth)acrylate, preferably with a weight-average molar mass in the range from 200 to 1000 g/mol, and/or polyethylene glycol di(meth)acrylate, preferably with a weight-average molar mass in the range from 200 to 1000 g/mol. Particular preference is given here to the dimethacrylates of the compounds mentioned. Very particularly advantageous results are achieved using polyethylene glycol dimethacrylate, preferably with a weight-average molar mass in the range from 200 to 1000 g/mo.

The proportion of monomer (A) is from 2 to 50% by weight, in particular from 10 to 30% by weight, based on all of the monomers used in the mixture.

For the purposes of the present invention, the mixture can comprise an aromatic vinyl compound.

Among the aromatic vinyl compounds, preference is given to the use of styrenes, substituted styrenes having an alkyl substituent in the side chain, e.g. α-methylstyrene and α-ethylstyrene, substituted styrenes having an alkyl substituent on the ring e.g. vinyltoluene and p-methylstyrene, halogenated styrenes such as monochlorostyrenes, dichlorostyrenes, tribromostyrenes, and tetrabromostyrenes,

and also to dienes, such as 1,2-divinylbenzene,
1,3-divinylbenzene, 1,4-divinylbenzene, 1,2-diisopropenylbenzene, 1,3-diisopropenylbenzene, and 1,4-diisopropenylbenzene.

The proportion of the aromatic vinyl compounds is preferably from 5 to 40% by weight, preferably from 10 to 30% by weight, particularly preferably from 15 to 25% by weight, based on the total amount of the compounds of the formula (I), (II), and (III) used in the prepolymer, the monomer (A) capable of free-radical polymerization, and the aromatic vinyl compounds and other monomers optionally used.

Surprisingly, the addition of monomer (A) and the aromatic vinyl compound improves the mechanical properties of the inventive plastics material without adversely affecting its optical properties. In many instances, a favourable effect on optical properties is found.

One particular aspect of the present invention may preferably utilize as compounds molecules having a linear structure and varying chain lengths (asymmetric crosslinking agents) of the general formula (XVI)

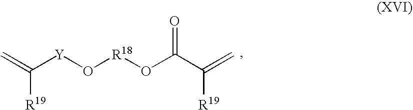

where the radical R¹⁹ is independently a hydrogen atom, a fluorine atom and/or a methyl group, the radical R¹⁸ is a connecting group, which preferably encompasses from 1 to 1000, in particular from 2 to 100, carbon atoms and the radical Y is a bond or a connecting group having from 0 to 1000 carbon atoms, in particular from 1 to 1000 carbon atoms, and preferably from 1 to 100 carbon atoms. The length of the molecule can be varied by way of the molecular component R¹⁸. Compounds of the formula (XVI) have, at one end of the molecule, a terminal (meth)acrylate function, and at the other end have a terminal group other than a methacrylate function. Among the preferred groups Y are in particular a bond (vinyl group) a CH₂ group (allyl group) and also aliphatic or aromatic groups having from 1 to 20 carbon atoms, for example a benzene-derived group the aliphatic or aromatic groups particularly preferably containing a urethane group.

The radical R¹⁸ is preferably a linear or branched, aliphatic or cycloaliphatic radical, such as a methylene, ethylene, propylene, isopropylene, n-butylene, isobutylene, tert-butylene or cyclohexylene group, or a radical of the general formula

(—R²⁰—X^{I}—)_{z}R^{21} (XVIa)

where the radical R²¹ is a linear or branched, aliphatic or cycloaliphatic radical or a substituted or unsubstituted aromatic or heteroaromatic radical, e.g. a methylene, ethylene, pro ylene, isopropylene, n-butylene, isobutylene, tert-butylene or cyclohexylene group, or divalent aromatic or heteroaromatic groups which derive from benzene, from naphthalene, from biphenyl, from diphenyl ether, from diphenylmethane, from diphenyldimethylmethane, from bisphenone, from diphenyl sulphone, from guinoline, from pyridine, from anthracene or from phenanthrene. For the purposes of the present invention, cycloaliphatic radicals here also encompass bi-, tri- and polycyclic aliphatic radicals. Each radical R²⁰, independently of the others, is a linear or branched, aliphatic or cycloaliphatic radical or a substituted or unsubstituted aromatic or heteroaromatic radical, e.g. a methylene, ethylene, propylene, isopropylene, n-butylene, isobutylene, tert-butylene or cyclohexylene group, or divalent aromatic or heteroaromatic groups which derive from benzene, from naphthalene, from biphenyl, from diphenyl ether, from diphenylmethane, from diphenyldimethylmethane from bisphenone, from diphenyl sulphone, from quinoline, from pyridine, from anthracene or from phenanthrene. For the purposes of the present invention, cycloaliphatic radicals here also encompass bi-, tri- and polycyclic aliphatic radicals. Each radical X¹, independently or the others, is oxygen sulphur, an ester group of the general formula (XVIb), (XVIc),

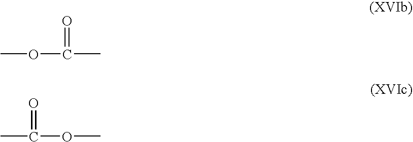

a urethane group of the general formula (XVId), (XVIe), (XVIf) or (XVIg),

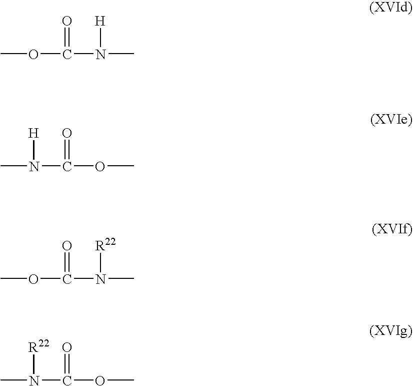

a thiourethane group of the general formula, (XVIh), (XVIi), (XVIj) or (XVIk),

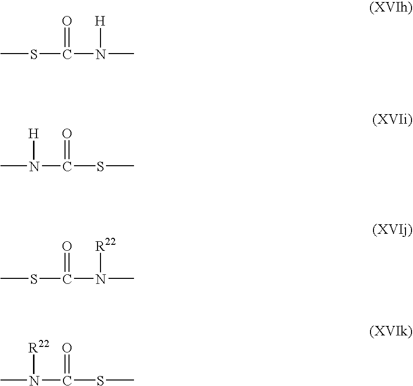

a dithiourethane group of the general formula (XVIl), (XVIm), (XVIn) or (XVIo)

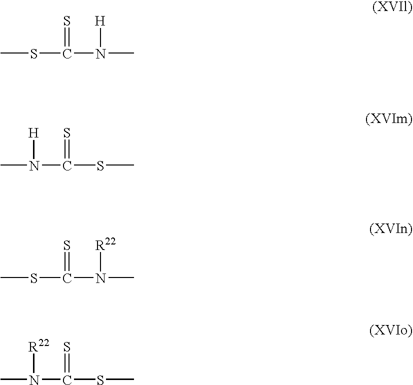

or a thiocarbamate group of the general formula (XVIp) (XVIq), (XVIr) or (XVIs)

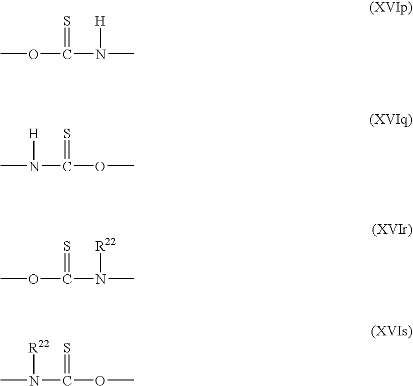

preferably oxygen, where the radical R²² is a linear or branched, aliphatic or cycloaliphatic radical or a substituted or unsubstituted aromatic or heteroaromatic radical, e.g. a methyl, ethyl, propyl, isopropyl, n-butyl, isobutyl, tert-butyl or cyclohexyl group, or monovalent aromatic or heteroaromatic groups derived from benzene, from naphthalene, from biphenyl, from d-phenyl ether, from diphenylmethane, from diphenyldimethylmethane, from bisphenone, from diphenyl sulphone, from quinoline, from pyridine, from anthracene, or from phenanthrene. For the purposes of the present inventions cycloaliphatic radicals here also encompass bi-, tri- and polycyclic aliphatic radicals. z is a whole number from 1 to 1000, advantageously from 1 to 100, in particular from 1 to 25.

In one particular embodiment of the formula (XVI) the compounds comprise those of the formula (XVII)

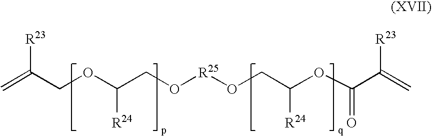

and/or of the formula (XVIII)

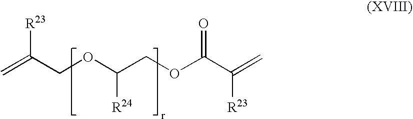

where each of the radicals R²³ and R²⁴, independently of the others, is hydrogen or a methyl radical, and the radical R²⁵ is a linear or branched, aliphatic or cycloaliphatic divalent radical, or a substituted or unsubstituted aromatic or heteroaromatic divalent radical. Preferred radicals have been described above.

The length of the chain may be influenced via variation of the number of polyalkylene oxide units, preferably polyethylene glycol units. Compounds of the formula (XVII) and (XVIII) which have proven particularly suitable for the method described here of achieving the object have numbers of polyalkylene oxide units r, p and q which are, independently of the others, from 1 to 40, preferably from 5 to 20, in particular from 7 to 15 and particularly preferably from 8 to 12.

According to the invention, very particular preference is given to asymmetric crosslinking agents encompassing compounds of the formula (XVIII), in particular

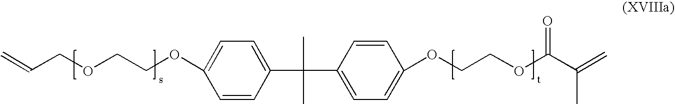

where s and t are greater than or equal to zero and the sum of s and t is preferably in the range from 1 to 20, in particular in the range from 2 to 10, and compounds of the formula (XVII), in particular

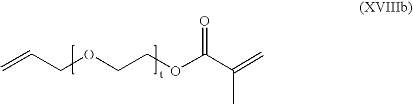

where s and t are greater than or equal to zero and the sum of s and t is preferably in the range from 1 to 20, in particular in the range from 2 to 10.

According to one particular aspect, the mixture preferably comprises from 0.5 to 40% by weight, in particular from 5 to 15% by weight, of compounds of the formula (XVI) and/or (XVII), based on the total weight of the monomer mixture.

For the purposes of one particularly preferred embodiment of the present invention, the inventive mixture also comprises at least one ethylenically unsaturated monomer (B). These monomers (B) differ from the asymmetric compounds of the formulae (XVII) and (XVIII), and from the monomers (A) and the thio(meth)acrylates of the formulae (I) and/or (II), The monomers (B are known to persons skilled in the art and are preferably copolymerizable with the monomers (A) and the thio(meth)acrylates of the formulae (I) and/or (II). Among these monomers (B) are in particular

nitrites of (meth)acrylic acid and other nitrogen-containing methacrylates, such as methacryloylamidoacetonitrile, 2-methacryloyloxyethylmethylcyanamide, cyanomethyl methacrylate;
(meth)acrylates which derive from saturated alcohols, e.g. methyl (meth)acrylate, ethyl (meth)acrylate, n-propyl (meth)acrylate, isopropyl (meth)acrylate, n-butyl(meth)acrylate, sec-butyl (meth)acrylate, tert-butyl (meth)acrylate, pentyl (meth)acrylate, hexyl (meth)acrylate, heptyl (meth)acrylate, 2-ethylhexyl (meth)acrylate, octyl (meth)acrylate, nonyl (meth)acrylate, isooctyl (meth)acrylate, isononyl (meth)acrylate, 2-tert-butylheptyl (meth)acrylate, 3-iospropylheptyl (meth)acrylate, decyl (meth)acrylate, undecyl (meth)acrylate, 5-methylundecyl (meth)acrylate, dodecyl (meth)acrylate, 2-methyldodecyl (meth)acrylate, tridecyl (meth)acrylate, 5-methyltridecyl (meth)acrylate, tetradecyl (meth)acrylate, pentadecyl (meth)acrylate, hexadecyl (meth)acrylate, 2-methylhexadecyl (meth)acrylate, heptadecyl (meth)acrylate, 5-isopropylheptadecyl (meth)acrylate, 4-tert-butyloctadecyl (meth)acrylate, 5-ethyloctadecyl (meth)acrylate, 3-isopropyloctadecyl (meth)acrylate, octadecyl (meth)acrylate, nonadecyl (meth)acrylate, eicosyl (meth)acrylate, cetyleicosyl (meth)acrylate, stearyleicosyl (meth)acrylate, docosyl (meth)acrylate and/or eicosyltetratriacontyl (meth)acrylate;
cycloalkyl (meth)acrylates, such as cyclopentyl (meth)acrylate, cyclohexyl (meth)acrylate, 3-vinyl-2-butylcyclohexyl (meth)acrylate and bornyl (meth)acrylate;
(meth)acrylates which derive from unsaturated alcohols e.g. 2-propynyl (meth)acrylate, allyl (meth)acrylate, and oleyl (meth)acrylate, vinyl (meth)acrylate;
aryl (meth)acrylates, such as benzyl (meth)acrylate or phenyl (meth)acrylate, wherein the aryl radicals may each be unsubstituted or substituted by up to four substituents;
hydroxyalkyl (meth)acrylates, such as 3-hydroxypropyl (meth)acrylate, 3,4-dihydroxybutyl (meth)acrylate, 2-hydroxyethyl (meth)acrylate, 2-hydroxypropyl (meth)acrylate, 2,5-dimethyl-1,6-hexanediol (meth)acrylate, 1,10-decanediol (meth)acrylate, 1,2-propanediol (meth)acrylate;
aminoalkyl (meth)acrylates, such as tris(2-methacryloxyethyl)amine, N-methylformamidoethyl (meth)acrylate, 2-ureidoethyl (meth)acrylate;
carbonyl-containing (meth)acrylates, such as 2-carboxyethyl (meth)acrylate, carboxymethyl (meth)acrylate, oxazolidinylethyl (meth)acrylate, N-(methacryloyloxy)formamide, acetonyl (meth)acrylate, N-methacryloylmorphoine, N-methacryloyl-2-pyrrolidinone;
(meth)acrylates of ether alcohols, e.g. tetrahydrofurfuryl (meth)acrylate, vinyloxyethoxyethyl (meth)acrylate, methoxyethoxyethyl (meth)acrylate, 1-butoxypropyl (meth)acrylate, 1-methyl-(2-vinyloxy)ethyl (meth)acrylate, cyclohexyloxymethyl (meth)acrylate methoxymethoxyethyl (meth)acrylate benzyloxymethyl (meth)acrylate, furfuryl (meth)acrylate, 2-butoxyethyl (meth)acrylate, 2-ethoxyethoxymethyl (meth)acrylate, 2-ethoxyethyl (meth)acrylate, allyloxymethyl (meth)acrylate, 1-ethoxybutyl (meth)acrylate, methoxymethyl (meth)acrylate, 1-ethoxyethyl (meth)acrylate, ethoxymethyl (meth)acrylate;
(meth)acrylates of halogenated alcohols such as 2,3-dibromopropyl (meth)acrylate, 4-bromophenyl (meth)acrylate, 1,3-dichloro-2-propyl (meth)acrylate, 2-bromoethyl (meth)acrylate, 2-iodoethyl (meth)acrylate, chloromethyl (meth)acrylate;
oxiranyl (meth)acrylates, such as 2,3-epoxybutyl (meth)acrylate, 3,4-epoxybutyl (meth)acrylate, glycidyl (meth)acrylate,
amides of (meth)acrylic acid, e.g. N-(3-dimethylaminopropyl)(meth)acrylamide, N-(diethylphosphono)(meth)acrylamide, 1-(meth)acryloylamido-2-methyl-2-propanol, N-(3-butylaminopropyl)(meth)acrylamide, N-tert-butyl-N-(diethylphosphono)(meth)acrylamide, N,N-bis(2-diethylaminoethyl)(meth)acrylamide, 4-(meth)acryloylamido-4-methyl-2-pentanol, N-(methoxymethyl)(meth)acrylamide, N-(2-hydroxyethyl)(meth)acrylamide, N-acetyl (meth)acrylamide, N-(dimethylaminoethyl) (meth) acrylamide, N-methyl-N-phenyl(meth)acrylamide, N,N-diethyl(meth)acrylamide, N-methyl(meth)acrylamide, N,N-dimethyl(meth)acrylamide, N-isopropyl(meth)acrylamide;
heterocyclic (meth)acrylates, such as 2-(1-imidazolylethyl (meth)acrylate, 2-(4-morpholinyl)ethyl (meth)acrylate and 1-(2-methacryloyloxyethyl-2-pyrrolidone;
phosphorus-, boron- and/or silicon-containing (meth)acrylates, such as 2-(dimethylphosphato)propyl (meth)acrylate, 2-(ethylenephosphito)propyl (meth)acrylate, dimethylphosphinomethyl (meth)acrylate, dimethylphosphonoethyl (meth)acrylate, diethyl (meth)acryloylphosphonate, dipropyl (meth)acryloyl phosphate;
sulphur-containing (meth)acrylates, such as ethylsulphinylethyl (meth)acrylate, 4-thiocyanatobutyl (meth)acrylate, ethylsulphonylethyl (meth)acrylate, thiocyanatomethyl (meth)acrylate, methylsulphinylmethyl (meth)acrylate, bis((meth)acryloyloxyethyl) sulphide;
bis(allyl carbonates, such as ethylene glycol bis(allyl carbonate), 1,4-butanediol bis(allyl carbonate), diethylene glycol bis(allyl carbonate);
vinyl halides, such as vinyl chloride, vinyl fluoride, vinylidene chloride and vinylidene fluoride;
vinyl esters, such as vinyl acetate.
heterocyclic vinyl compounds, such as 2-vinylpyridine, 3-vinyl pyridine 2-dimethyl-5-vinylpyridine 3-ethyl-4-vinylpyridine, 2,3-dimethyl-5-vinylpyridine, vinylpyrimidine, vinylpiperidine, 9-vinylcarbazole, 3-vinylcarbazole, 4-vinylcarbazole, 1-vinylimidazole, 2-methyl-1-vinylimidazole, N-vinylpyrrolidone, 2-vinylpyrrolidone, N-vinylpyrrolidine, 3-vinylpyrrolidine, N-vinylcaprolactam, N-vinylbutyrolactam, vinyloxolane, vinylfuran, vinylthiophene, vinylthiolane, vinylthiazoles and hydrogenated vinylthiazoles, vinyloxazoles and hydrogenated vinyloxazoles;
vinyl ethers and isoprenyl ethers;
maleic acid and maleic acid derivatives, such as mono- and diesters of maleic acid, the alcohol radicals having from 1 to 9 carbon atoms,
maleic anhydride, methylmaleic anhydride, maleimide, methylmaleimide;
fumaric acid and fumaric acid derivatives, such as mono- and diesters of fumaric acid, the alcohol radicals having from 1 to 9 carbon atoms.

For completeness, a di(meth)acrylate listed under monomer (A) may also be used as monomer (B).

The term (meth)acrylates encompasses methacrylates and acrylates and also mixtures of the two. Correspondingly, the term (meth)acrylic acid encompasses methacrylic acid and acrylic acid and also mixtures of the two.

The ethylenically unsaturated monomers may be used individually or in the form of a mixture.

In principle, the composition of the invention monomer mixtures may be as desired. It can be utilized to match the property profile of the inventive plastic to the demands of the application.

However, it has proven to be highly advantageous select the composition of the monomer mixture in such a way that the inventive thio(meth)acrylate, preferably a prepolymer prepared from the compound(s) of the formula (I), (II) and (III), and preferably at least one monomer (A), and also, where appropriate, styrene mix homogeneously at the desired polymerization temperature because handling of mixtures of this type is easy as a consequence of their generally low viscosity and more over because they can be polymerized to give homogeneous plastics with improved properties

According to one particularly preferred embodiment of the present invention, the monomer mixture comprises a prepolymer, prepared from at least 5.0% by weight, preferably at least 20.0% by weight, particularly preferably at least 50.0% by weight, of compounds of the formula (I), (II) and (III), based in each case on the total weight of the monomer mixture. The content by weight of monomer (A) is preferably at least 2.0% by weight, with preference at least 10.0% by weight, particularly preferably at least 20.0% by weigh, based in each case on the total weigh, of the monomer mixtures. The content by weight of aromatic vinyl compounds, in particular styrene, is preferably at least 2.0% by weight, preferably at least 10.0% by weight, particularly preferably at least 20.0% by weight, based in each case on the total weight of the monomer mixture.

According to one particular aspect of the present invention, the mixture comprises

from 40 to 1000% by weight, preferably from 50 to 90% by weight, in particular from 60 to 85% by weight, of the inventive thio(meth)acrylates, which in particular are obtainable from compounds of the monomers of the formulae (I) and/or (II), and also (III),
from 0 to 60% by weights preferably from 2 to 50% by weight, in particular from 10 to 30% by weight, of monomers (A) and
from 0 to 60% by weight, preferably from 2 to 50% by weight in particular from 10 to 30% by weight, of aromatic vinyl compounds, in particular styrene and
from to 45% by weight, in particular from 1 to 10% by weight, of monomers of the formulae (XVI) and (XVII) and/or monomers (B), based in each case on the total weight of the monomer mixture.

The preparation of the monomer mixture to be used with preference is known to the person skilled in the art. By way of example, it can take place via mixing of the inventive thio(meth)acrylates, preferably prepolymers, obtainable from the reaction of compounds of the formulae (I) and/or (II) with compounds (III), of the aromatic vinyl compounds and also of the monomers (A) and (B) in a manner known per se.

For the purposes of the present invention, the monomer mixture is preferably flowable at atmospheric pressure and temperatures in the range from 20 to 80.0° C. The term “flowable” is known to the person skilled in the art. It characterizes a liquid which can preferably be cast into various shapes and, using suitable aids, stirred and homogenized. For the purposes of the invention, particular flowable materials have, in particular at 25° C. and at atmospheric pressure (101325 Pa) dynamic viscosities of the order of from 0.1 mPa·s to 10 Pa·s, advantageously in the range from 0.6 mPa·s to 1 Pa·s. In one particularly preferred embodiment of the present invention, a cast monomer mixture has no bubbles, in particular no air bubbles. Preference is likewise given to monomer mixtures from which bubbles, in particular air bubbles, can be removed via suitable processes, such as temperature increase and/or application of vacuum.

The inventive high-transparency plastic is obtainable via free-radical copolymerization of the low-viscosity (η<200 mPa·s) monomer mixture described above. Free-radical copolymerization is a well-known process initiated via free radicals, converting a mixture of low-molecular monomers into high-molecular-weight compounds, known as polymers. For further details reference is made to the disclosure of H. G. Elias, Makromoleküle [Macromolecules], Volume 1 and 2, Basle, Heidelberg, New York Hüthig und Wepf. 1990 und Ullmann's Encyclopedia of Industrial Chemistry, 5th edition, headword “Polymerization Processes”.

In one preferred embodiment of the present inventions the inventive plastic is obtainable via mass or bulk polymerization of the monomer mixture. Mass or bulk polymerization here means a polymerization process in which monomers are polymerized without solvent, the polymerization reaction therefore being carried out on the undiluted material or in bulk. Processes which contrast with this are polymerization in emulsion (known as emulsion polymerization) and polymerization in a dispersion (known as suspension polymerization), in which the organic monomers are suspended with protective colloids and/or stabilizers in an aqueous phase, and relatively coarse polymer particles are formed. A particular form of heterogeneous-phase polymerization is bead polymerizations which in essence is a type of suspension polymerization.

In principles the polymerization reaction may be initiated in any manner familiar to the person skilled in the art, for example using a free-radical initiator (e.g. peroxide, azo compound) or via irradiation with UV rays or with visible light, α-radiation, β-radiation or γ-radiation, or a combination of these.

In one preferred embodiment of the present invention, lipophilic free-radical polymerization initiators are used to initiate the polymerization. The free-radical polymerization initiators are in particular lipophilic in order to dissolve in the bulk polymerization mixture. Among compounds which may be used, besides the traditional azo initiators, such as azoisobutyronitrile (AIBN) or 1,1-azobiscyclohexanecarbonitrile, are, inter alia aliphatic peroxy compounds, such as tert-amyl peroxyneodecanoate, tert-amyl peroxypivalate tert-butyl peroxypivalate, tert-amyl 2-ethylperoxyhexanoate, tert-butyl 2-ethylperoxyhexanoate tert-amyl 3,5,5-trimethylperoxyhexanoate, ethyl 3,3-di(tert-amylperoxy)butyrate, tert-butyl perbenzoate, tert-butyl hydroperoxide, decanoyl peroxide, lauryl peroxide, benzoyl peroxide and any desired mixtures of the compounds mentioned. Among the abovementioned compounds, very particular preference is given to AIBN.

In another preferred embodiment of the present invention, the polymerization is initiated by using known photoinitiators, via irradiation with UV rays or the like. Use may be made here of the familiar, commercially available compounds, e.g. benzophenone, α,α-diethoxyacetophenone, 4,4-diethylaminobenzophenone, 2,2-dimethoxy-2-phenylacetophenone, 4-isopropylphenyl 2-hydroxy-2-propyl ketone, 1-hydroxycyclohexyl phenyl ketone, isoamyl p-dimethylaminobenzoate, methyl 4-dimethylaminobenzoate, methyl o-benzoylbenzoate, benzoin, benzoin ethyl ether, benzoin isopropyl ether, benzoin isobutyl ether, 2-hydroxy-2-methyl-1-phenylpropan-1-one, 2-isopropylthioxanthone, dibenzo-suberone, 2,4,6-trimethylbenzoyldiphenylphosphine oxide, bisacylphosphine oxide and other compounds, and the photoinitiators mentioned here may be used alone or in a combination of two or more or in combination with one of the above polymerization initiators.

The amount of the free-radical generators may vary widely. By way of example, amounts preferably used are in the range from 0.1 to 5.0% by weight, based on the weight of the entire composition. Particular preference is given to the use of amounts in the range from L 0 to 2.0% by weight, in particular amounts in the range from 0.1 to 0.5% by weight, based in each case or the weight of the entire composition.

The polymerization temperature to be selected for the polymerization is obvious to the person skilled in the art. It is primarily determined via the initiator selected and the manner of initiation (thermal, via irradiation, etc.). It is known that the polymerization temperature can affect the properties of a polymer product. For the purposes of the present invention, preference is therefore given to polymerization temperatures in the range from 20.0 to 100.0° C., advantageously in the range from 20.0 to 80° C., in particular in the range from 20.0 to 60.0° C. In one particularly preferred embodiment the present invention, the reaction temperature is increased during the reaction, preferably in stages.

Heat-conditioning a an elevated temperature has also proven to be advantageous, for example at from 100 to 150° C., towards the end of the reaction.

The reaction may take place either at subatmospheric pressure or else at superatmospheric pressure. However, it is preferably carried out at atmospheric pressure. The reaction may take place in air or else under an inert gas, preferably with a minimum content of oxygen present, because this content has an inhibiting effect on any polymerization.

In one particularly preferred embodiment of the present invention, the procedure for preparing the inventive high-transparency plastic prepares a homogeneous mixture from the components, these being monomer mixture, initiator and other additives, e.g. lubricants, and then charges these between glass plates whose shape has been predetermined via the subsequent application, e.g. in the form of spectacle lenses or other lenses, prisms or other optical components. The bulk polymerization is initiated via introduction of energy, for example via high-energy radiation, in particular using UV light, or via heating, advantageously. In a water bath and for two or more hours. This gives the optical material in its desired form as clear, transparent colourless, hard plastic.

For the purposes of the present invention, lubricants are additives for charges of plastic materials, such as compression-moulding materials and injection-moulding materials, their function being to increase the slip capability of the materials charged and thus to ease the moulding of the compression-moulding materials. Examples of substances suitable for this purpose are metal soaps and siloxane combinations. The insolubility of the lubricant in plastics causes some of the lubricant to migrate to the surface during processing, where it acts as a release agent. Particularly suitable lubricants, such as non-ionic fluorinated agents with surface activity, non-ionic silicone agents with surface activity, quaternary alkylammonium salts and acidic phosphate esters, are described in EP 271839 A, the disclosure of which is expressly incorporated by reference for the purposes of the present invention.

The invention provides a high-transparency plastic with very good optical and mechanical properties. For example, its transmittance to DIN 5036 is preferably greater than 88.0%, advantageously greater than 89.0%.

The refractive index n_{D} of the inventive plastic is preferably greater than or equal to 1.59. The refractive index of a medium is generally dependent on the wavelength of the incident radiation and on the temperature. The inventive data for refractive index are therefore based on the standard data specified in DIN 53491 (standard wavelength of the (yellow) D line of sodium (about 589 nm)).

According to the invention, the Abbe number of the plastic is preferably >36.0 to DIN 53491. Information concerning the Abbe number can be found by the person skilled in the art in the literature, for example in the Lexikon der Physik [Dictionary of Physics] (Walter Greulich (ed.); Lexikon der Physik [Dictionary of Physics]; Heidelberg; Spektrum, Akademischer Verlag; Volume 1; 1998).

According to one particularly preferred embodiment of the present invention, the plastic has an Abbe number >36.0, advantageously >37.0, in particular >38.0.

The FDA falling ball test (ANSI Z 80.1) is used to test mechanical properties. The test is passed if the test specimen is undamaged by a ball of diameter 16 mm. The greater the diameter of the ball used in the test without damaging the specimen, the better the mechanical properties.

The inventive plastic also advantageously has a high glass transition temperature, and therefore maintains its outstanding mechanical properties, in particular its impact strength and its hardness, even at temperatures above room temperature. The glass transition temperature of the inventive plastic is preferably greater than 80° C., advantageously greater than 90° C., in particular greater than 95° C.

Possible fields of use for the inventive thio(meth)acrylates and the transparent plastics obtainable therefrom are obvious to the person skilled in the art. The plastics are particularly suitable for any application destined for transparent plastics. Its characteristic properties make it especially suitable for optical lenses, in particular for ophthalmic lenses. The thio(meth)acrylates are moreover valuable substances which can be used coating compositions for synthetic fibres.

The invention also provides a mixture comprising at least one photochromic dye. Use may be made here of any the photochromic dyes known to the person skilled in the art and of their mixtures. Examples of preferred photochromic dyes are spiro(indolines)naphthoxazines, spiro(indolines) benzoxazines, spiropyrans, acetanilides, aldehyde hydrazones, thioindigo, stilbene derivatives, rhodamine derivatives and anthraquinone derivatives, benzofuroxans, benzopyrans, naphthopyrans, organometallic dithiozonates, fulgides and fulgimides.

From these mixtures it is possible to prepare photochromic materials which are used by way of example as lenses, preferably optical lenses, glass panes or glass inserts.

The following inventive examples and the comparative example serve to illustrate the invention, with no intended resultant restriction.

### EXAMPLES

### Synthesis of the Thiomethacrylate Mixture

75.36 g of 1,2-ethanedithiol are weighed into an Erlenmeyer flask with inert gas feed and stirred, and 416.43 g of 13% strength NaOH solution are metered in within a period of 30 minutes at from 25 to 30° C., with water cooling. A brownish, clear solution forms.

178.64 g of methacrylic anhydride and the Na thiolate solution are then metered in parallel at the desired metering temperature within a period of 45 minutes into the initial charge of stirred ethyl acetate/water in the reaction flask. Where appropriate here, inert gas is passed over the mixture. The contents of the flask generally become cooler by about 2° C. at the start of the feed, and a slightly exothermic reaction begins after about 5-10 minutes, meaning that appropriate cooling is applied in order to maintain the desired reaction temperature (35° C.). Once the feed has ended, the mixture is stirred for a further 5 minutes at 35° C. and is then cooled, with stirring, to about 25° C.

The mixture is transferred to a separating funnel and separated, and the lower, aqueous phase is discharged. For work-up, the organic phase is transferred to an Erlenmeyer flask and stirred with ®Dowex M-31 for about 15 minutes, the ion exchanger then being filtered off.

The somewhat cloudy to almost clear crude ester solution is then stabilized with 100 ppm of HQME and concentrated at not more than 50° C. on a rotary evaporator. The colourless final product is filtered at room temperature (20-25° C.). This gives about 140 g of colourless, clear ester.

Preparation of prepolymer: reaction of 6.84 g of the thiodi(meth)acrylate and 0.36 g of DMDO in the presence of an amine as catalyst, the method being based on EP 284374.

In an example of the preparation of a polymer based on an oligomeric thiodimethacrylate, 7.2 g of the prepolymer, 2.4 g of styrene, 2.4 g of decaethoxylated bisphenol A di(meth)acrylate, 0.1 g of hydroxyethyl methacrylate, 36 mg of a UV initiator, e.g. Irgacur 819, and 24 mg of tert-butyl peroctoate or similar initiators (cf. Inventive Example 1 are mixed. The homogeneous casting resin mixture is placed in an appropriate mould and hardened within a period of 10 min in a UV curing system using a 1200 row high-pressure mercury source. The material is then heat-conditioned for a further period of about 2 h at about 120° C. in an oven.

| | | | | | | | Average |
|---|---|---|---|---|---|---|---|
| | | Refractive/ | | | | FDA | ball |
| | | Abbe | | | | falling | diameter |
| | | coefficient DIN | | | | ball test | in mm, |
| | | 53491 | | | | diameter | test |
| Experiment | System | 589 nm | | Odour | Transmittance | ANSI Z80.1 | passed |
| Inventive | | | | | | | |
| Examples | | | | | | | |
| IE 1 | PLEX 6931/DMDO prepolymer co | 1.5939 | 38.2 | no | 89 | passed | 18 |
| | styrene co E10BADMA = 60:20:20 | | | | | | |
| | plus 1% HEMA | | | | | | |
| Comparative | | | | | | | |
| Examples | | | | | | | |
| CE I | PLEX 6931 co DMDO co styrene co | — | — | yes | — | — | — |
| | E10BADMA = 57:3:20:20 plus 1% | | | | | | |
| | HEMA (#) | | | | | | |
| CE II | PLEX 6931 co styrene co E10BADMA = 60:20:20 | 1.5959 | 34.9 | no | 89 | passed | 16 |
| | plus 1% HEMA | | | | | | |
| CE III | PLEX 6931/DMDO prepolymer co | 1.6089 | 29.6 | no | 89 | passed | 16 |
| | styrene = 70:30 plus 1% HEMA | | | | | | |

Plex 6931 O: reaction product from methacrylic anhydride and ethanedithiol from DE 316671
E10BADMA: ethoxylated bisphenol A dimethacrylate, degree of ethoxylation about 10
DMDO: dimercaptodioxaoctane
HEMA: hydroxyethyl methacrylate
(#): no further analysis was undertaken, because of the problems of odour.

The inventive mixture (IE 1) is odourless. The Comparative Example CE I did not pass this test and was therefore not studied further.

For comparable refractive index (of IE 1 with CE IT and CE III) the Abbe number was nevertheless better for the inventive mixture. The inventive mixture also performed substantially better in the falling ball test.

1. A thio(meth)acrylate, obtainable via the reaction of compounds of formula (I) and/or (II) 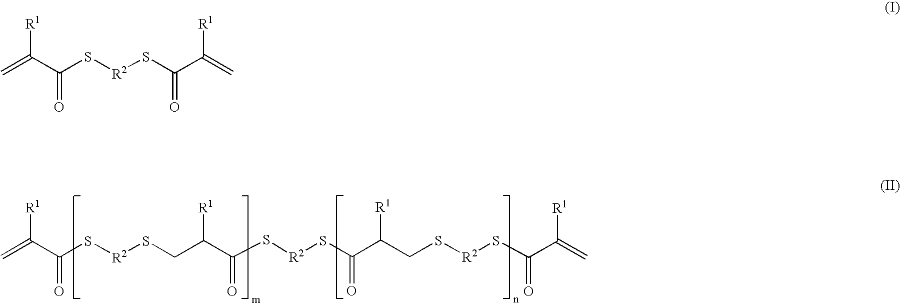
where each R₁, independently of the others, is hydrogen or a methyl radical,
each R², independently of the others, is a linear or branched, aliphatic or cycloaliphatic radical, or a substituted or unsubstituted aromatic or heteroaromatic radical, and each of m and n, independently of the others, is a whole number greater than or equal to 0, where m+n>0,
with thiol compounds which contain at least two thiol groups.

2: The thio(meth)acrylate according to claim 1, characterized in that the thiol compounds are alkyldithiols or polythiols.

3: The thio(meth)acrylate according to claim 1, characterized in that the thiol compounds are compounds of formula (III)
HS—R³—SH (III),
where R³ is a linear or branched, aliphatic or cycloaliphatic radical or a substituted or unsubstituted aromatic or heteroaromatic radical.

4: The thio(meth)acrylate according to claim 1, characterized in that the molar ratio of compounds of formula (I) and/or (II) to the thiol compounds containing at least two thiol groups is in the range from 50:1 to 1:2.

5: The thio(meth)acrylate according to claim 1, characterized in that the mixture for preparing the thio(meth)acrylate comprises more than 5.8 mol %, based on the total amount of the compounds of formula (I), (II) and (III), of compounds of formula (II) where m+n=3.

6: The thio(meth)acrylate according to claim 1, characterized in that the mixture for preparing the thio(meth)acrylate comprises from 1 to 50 mol %, based on the total amount of the compounds of formula (I), (II) and (III), of compounds of formula (I).

7: The thio(meth)acrylate according to claim 1, characterized in that the mixture for preparing the thio(meth)acrylate comprises from 1 to 40 mol %, based on the total amount of the compounds of formula (I), (II) and (III), of compounds of formula (II) where m+n=1.

8: The thio(meth)acrylate according to claim 1, characterized in that the mixture for preparing the thio(meth)acrylate comprises compounds of formula (II) where m+n>3.

9: The thio(meth)acrylate according to claim 1, characterized in that the total content of compounds of formula (I), (II) and (III) is at least 5.0% by weight, based on the total weight of the mixture for preparing the thio(meth)acrylate.

10: The thio(meth)acrylate according to claim 1, characterized in that the mixture for preparing the thio(meth)acrylate comprises more than 10 mol %, based on the total amount of the compounds of formula (I), (II) and (III), of compounds of formula (II) where m+n=2.

11: A thio(meth)acrylate comprising compounds of the formulae
A-Y-A (IV-a)
and/or
A-Y-Z-B (IV-b)
and/or
A-(Y-Z)_{q}-Y-A (IV-c)
and/or
B-(Z-Y)ᵣ-Z-B (IV-d)
and/or
A-(Y-Z)ₛ-B (IV-e)
where q, r and s are whole numbers in the range from 1 to 100,
A is an end group of the formulae 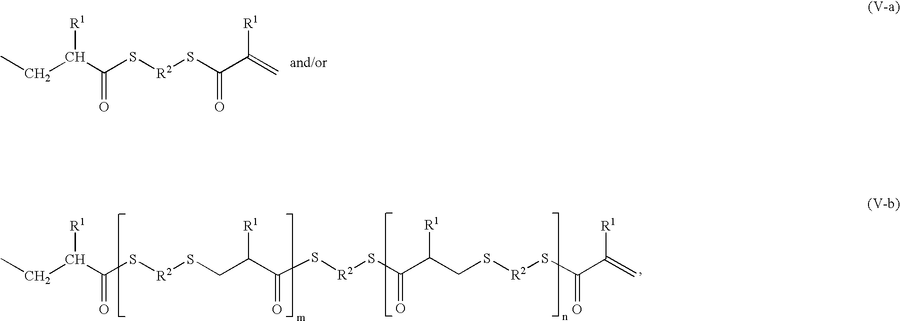
B is an end group of the formula 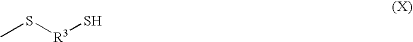
Z is a connecting group of the formulae 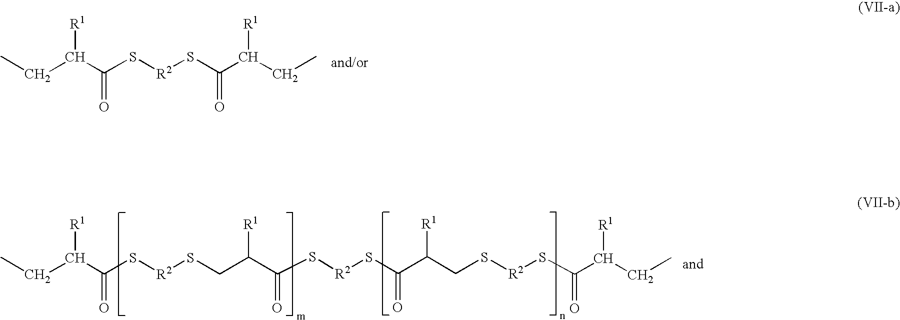
Y is a connecting group of the formulae 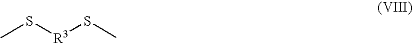
where
each R¹, independently of the others, is hydrogen or a methyl radical,
each R², independently of the others, is a linear or branched, aliphatic or cycloaliphatic radical, or a substituted or unsubstituted aromatic or heteroaromatic radical, and each of m and n, independently of the others, is a whole number greater than or equal to 0, where m+n>0, and
R³ is a linear or branched, aliphatic or cycloaliphatic radical or a substituted or unsubstituted aromatic or heteroaromatic radical.

12: The thio(meth)acrylate according to claim 1, characterized in that the weight-average molecular weight of the thio(meth)acrylate is in the range from 300 to 5000 Da.

13: The thio(meth)acrylate according to claim 11, characterized in that the viscosity of the thio(meth)acrylate determined at 25° C. is in the range from 100 to 1000 mPa·s.

14: The thio(meth)acrylate according to claim 11, characterized in that the radical R² of formula (I), (II), (IV), (V) and/or (VII) is an aliphatic radical having from 1 to 10 carbon atoms.

15: A mixture for preparing transparent plastics, comprising
a) at least one thio(meth)acrylate according to of claim 1,
b) at least one monomer (A) capable of free-radical polymerization and having at least 2 methacrylate groups and
c) at least one aromatic vinyl compound.

16: The mixture according to claim 15, comprising
d) a monomer capable of free-radical polymerization and having at least two terminal olefinic groups whose reactivity differs, and/or
e) at least one ethylenically unsaturated monomer (B).

17: The mixture according to claim 15, characterized in that the mixture comprises at least one monomer (A) which is copolymerizable with the thio(meth)acrylate.

18: The mixture according to claim 17, characterized in that the mixture comprises di(meth)acrylates.

19: The mixture according to claim 15, characterized in that the aromatic vinyl compound present in the mixture comprises styrene.

20: The mixture according to at lest one claim 15, characterized in that it comprises a monomer capable of free-radical polymerization and having at least two terminal olefinic groups whose reactivity differs, of the general formula 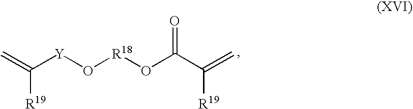
where
the radical R¹⁹ is independently a hydrogen atom, a fluorine atom, and/or a methyl group,
the radical R₁₈ is a connecting group which preferably encompasses from 1 to 1000 carbon atoms, and
the radical Y is a bond or a connecting group having from 0 to 1000 carbon atoms.

21: The mixture according to claim 20, characterized in that it comprises allyl polyethylene glycol methacrylate.

22: The mixture according to claim 15, characterized in that the mixture comprises at least one (meth)acrylate.

23: The mixture according to claim 22, characterized in that it comprises 2-hydroxyethyl methacrylate.

24: The mixture according to claim 15, characterized in that the mixture comprises at least one photochromic dye.

25: A process for preparing transparent plastics, characterized in that a mixture according to claim 15 is polymerized.

26: A transparent plastic obtainable via a process according to claim 25.

27: The plastic according to claim 26, characterized in that the refractive index of the plastic to DIN 53491 is greater than 1.59.

28: The plastic according to claim 26, characterized in that the Abbe number of the plastic to DIN 53491 is greater than 36.

29: The plastic according to claim 26, characterized in that the average diameter of the ball which does not damage the test specimen in the falling ball test is ≧18.

30: The plastic according to claim 26, characterized in that the transmittance of the plastic to DIN 5036 is ≧89%.

31: The plastic according to claim 26, characterized in that its glass transition temperature is greater than 80.0° C.

32: The plastic according to claim 26, characterized in that the plastic has photochromic properties.

33: A lens or glass pane or glass inset composed of the plastic according to claim 32.

34: An optical lens comprising the transparent plastic according to claim 26.

35: An ophthalmic lens comprising the transparent plastic according to claim 26.
